(19) United States
(12) Patent Application Publication
(10) Pub. No.: US 2004/0247179 A1
(43) Pub. Date: Dec. 9, 2004

(54) Image processing apparatus, image processing method, and image processing program

(75) Inventors: Shinji Miwa, Nirasaki-shi (JP); Naoki Kayahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/809,836

(22) Filed: Mar. 26, 2004

(30) Foreign Application Priority Data
Mar. 31, 2003 (JP) 2003-097063
Mar. 31, 2003 (JP) 2003-097064
Feb. 5, 2004 (JP) 2004-029437

(51) Int. Cl. G06K 9/34; G06K 9/38

(52) U.S. Cl. 382/173; 382/199

(57) ABSTRACT

To provide an image processing apparatus, an image processing method, and an image processing program of detecting an obscure portion that cannot be divided by clear edges as a boundary region and of controlling image information on the boundary region so as to be suitable for a background image in the case of dividing a target image into image object regions, a boundary region having intermediate characteristics between the characteristics of a target image object and the characteristics of an adjacent image object that are two adjacent image objects is detected from a target image. Pixel information on the pixels that belong to the boundary region is generated based on the changes in the characteristics of the pixels from the pixels of the boundary region which contact the target image object region having the characteristics of the target image object to the pixel of the boundary region that contacts an adjacent image object region having the characteristics of the adjacent image object.

### BACKGROUND OF THE INVENTION

1. Field of Invention

The present invention relates to an image processing apparatus, an image processing method, and an image processing program, and in particular, to an image processing apparatus, an image processing method, and an image processing program to divide a target image, composed of a plurality of pixels and whose edges cannot be determined, into a plurality of image regions based on information on the pixels.

2. Description of Related Art

A process of dividing a target image into image regions composed of image object regions is necessary to visualize, correct, and enhance the image of objects that exist in the target image. However, a natural image photographed by a digital camera or scanned from a picture by a scanner may not be distinguished by clear edges. Even in this case, it is necessary to divide the target image into the image object regions for subsequent processes. Therefore, there are several methods of dividing the target image into the image object regions in the related art.

When the image object selected from the target image is composed with a background image that is another image to thus generate a synthesized image, a method of removing a sense of incongruity between the periphery of the divided image object region and the background image is considered.

A method of generating a synthesized image by a related art region dividing process will now be described with reference to FIGS. 20 to 23.

According to the related art region dividing process, portions in which there exists a large difference in the characteristics of two adjacent pixels are detected as edges. A closed region composed of the detected edges is one image object region.

FIG. 20 is a schematic illustrating bit map data of 3×3 pixels. FIG. 21 is a flow chart of the synthesized image generating process performed by determining edges.

The flow chart of FIG. 21 will now be described with reference to FIG. 20. Also, each pixel includes position information identified by the X coordinates and the Y coordinates as pixel information. Furthermore, the pixel is referred to as p(x, y). The characteristics of the pixel are described with reference to a color value, a chroma value, and a brightness value, as values that represent the characteristics of the pixel p(x, y). In FIG. 22, the center point of the boundary between adjacent pixels is referred to as a boundary point and f(x1, y1, x2,y2). The boundary point f(x1, y1, x2,y2)is the center point of the boundary between a pixel p(x1, y1) and a pixel p(x2, y2).

In FIG. 21, attention is paid to a pixel p(0, 0) (S1 301), and the characteristics of the pixel p(0, 0) are compared with those of a pixel p(1, 0) (SI 302) in the synthesized image generating process by edge determination. At this time, the pixel p(0, 0), to which attention is to be paid, is referred to as an attention pixel. The pixel p(1, 0), to be compared with the attention pixel p(0, 0), is referred to as a comparison pixel. As a result, when the difference in the characteristics between the pixel p(0, 0) and the pixel p(1, 0) is larger than a predetermined edge determination threshold value (S1303: YES), a boundary point f(0, 0, 1, 0) is determined as an edge point (S1304). For example, when it is determined that the color value as an edge determination threshold value is 15, the difference between the color value (=30) of the pixel p(0, 0) and the color value (=0) of the pixel p(1, 0) is larger than the edge determination threshold value. Therefore, the boundary point f(0, 0, 1, 0) is determined as an edge point. Then, the characteristics of the pixel p(0, 0) are compared with those of the pixel p(0, 1) (S1306). When the difference in the characteristics between the pixel p(0, 0) and the pixel p(0, 1) is larger than a predetermined edge determination threshold value (S1307: YES), a boundary point f(0, 0, 0, 1) is determined as an edge point (S1308). Since the difference between the color value (=30) of the pixel p(0, 0) and the color value (=30) of the pixel p(0, 1) is equal to or smaller than the edge determination threshold value, a boundary point f(0, 0, 0, 1) is not determined as an edge point.

Then, an edge point is detected by moving an attention pixel to the pixel p(l, 0) (S1309, S1311, or S1312) and by comparing the pixel p(1, 0) with a pixel p(2,0). The edge points of all of the pixels that constitute a target image are detected while moving the attention pixel (S1305, S1310, or S1313). Therefore, in FIG. 20, the boundary points marked with black circles are detected as edge points.

Then, it is determined whether the group of adjacent edge points constitutes a closed region (S1314). In FIG. 20, the region composed of the group of edge points within distance 1 is detected as the closed region (S1315). Therefore, the closed region composed of the pixels p(0, 0), p(0, 1), p(0, 2), and p(1, 2) and the closed region composed of the pixels p(1, 0), p(2, 0), p(1, 1), p(2, 1), and p(2, 2) are detected.

When a synthesized image is generated (S1316: YES), each of the image information items of a selected image object and a selected background image to generate more synthesized images is obtained (S1317). Mixture and smoothing processes are performed on the periphery of the boundary between the selected image object and the selected background image (S1318) to thus generate a synthesized image (S1319).

When a synthesized image is generated by synthesizing a target image object region in a target image with a background image, which is another image, so as to remove the difference in the photographing conditions when the target image is photographed and those when the background image is photographed, based on the photographing conditions, the image information on a part or all of the region of either the image information on the target image object region or the image information on the background image is controlled.

### SUMMARY OF THE INVENTION

However, in a photograph or the like, an image object region in a target image is not distinguished by clear edges due to deviation of a point during photographing and characteristics of a photographing element and generates a boundary region of small width. FIG. 22 is a schematic diagram illustrating a boundary region simplified by bit map data of 3×6 pixels. In FIG. 22, a group of pixels composed of pixels marked with Xs correspond to the boundary region 1103. The pixels that exist in the boundary region 1103 have a medium color between the colors of two image object regions 1101 and 1102 that interpose the boundary region 1103. Therefore, according to the above-mentioned region dividing method, it is not possible to detect the difference in the characteristics of the pixels, which exceeds the edge determination threshold value. That is, since it is not possible to detect the edges in the target image, it is not possible to distinguish the image object region by clear edges.

Therefore, when the above-mentioned region dividing process is applied to the image illustrated in FIG. 23A when the edge determination threshold value for an edge detecting process is too large, one image object region is not distinguished from the other image object region in an obscure portion, as illustrated in FIG. 23B, so that the entire region is determined as one image object region. When the edge determination threshold value for the edge detecting process is too small, as illustrated in FIG. 23C, the respective image object regions have unnatural shapes that do not include the obscure portion so that pixels significantly change inside the obscure portion. Therefore, the obscure portion is determined not to be an image object region. Here, the shaded portion represents the obscure portion.

When a target image object region in a target image is synthesized with a background image that is another image, to thus generate a synthesized image, in the target image, when the obscure portion exists in the boundary between an image object region adjacent to the target image object region and the target image object region, the target image object region is synthesized with the background image with a region in which the characteristics of the adjacent image object region, remain included in the peripheral edge of the target image object region. Therefore, a synthesized image in which there exists a sense of incongruity around the target image object region may be obtained. When it is not possible to distinguish the target image object region, it is not possible to generate a synthesized image.

In order to address the above-mentioned problems, when a target image is divided into image object regions, an aspect of the present invention to provide an image processing apparatus, an image processing method, and an image processing program capable of detecting an obscure portion that cannot be distinguished by clear edges as a boundary region and of dividing the target image into the image regions composed of the image object regions and the boundary regions. An aspect of the present invention also provides an image processing apparatus, an image processing method, and an image processing program capable of dividing the boundary region interposed between the two detected image object regions into regions by a predetermined method and of making the respective divided regions belong to the respective image object regions to thus divide the target image into the image object regions.

When a target image is divided into image object regions, an aspect of the present invention provides an image processing apparatus, an image processing method, and an image processing program capable of detecting an obscure portion that cannot be distinguished by clear edges as a boundary region and of generating transparency information from which the influence of an image object region adjacent to a target image object region is more removed than from the image information on the boundary region of the target image object region to thus detect the region information on the target image object region regardless of the adjacent image object region.

An aspect of the present invention also provides an image processing apparatus, an image processing method, and an image processing program capable of changing image information on the boundary of a target image object region into information suitable for a background image to thus generate an image obtained by synthesizing the target image object region with the background image with no sense of incongruity around the target image object region.

In order to address the above-mentioned problems, a first aspect of the present invention is an image processing method of detecting a target image composed of a set of a plurality of pixels in each of a plurality of image object regions, when one of adjacent image object regions is a first image object region and the other image object region is a second image object region, a group of boundary pixels interposed between a first group of pixels that constitute the first image object region and a second group of pixels that constitute the second image object region is detected as a boundary region between the first image object region and the second image object region based on pixel information on the pixels and predetermined region-determining conditions.

In this way, since it is possible to detect an obscure portion between the image object regions, which cannot be distinguished by clear edges, as the boundary region that is an independent region, it is possible to distinguish the target image as one image region composed of the image object region and the boundary region. The pixel information according to an aspect of the present invention refers to information including the positions of pixels in the target image in addition to the pixel values, such as the following RGB and CMYK values (the same is true of the following image processing apparatus and image processing program).

A second aspect of the present invention is an image processing method of dividing a target image composed of a set of a plurality of pixels into a plurality of image object regions, when one of adjacent image object regions is a first image object region and the other image object region is a second image object region, a group of boundary pixels interposed between a first group of pixels that constitute the first image object region and a second group of pixels that constitute the second image object region is detected as a boundary region between the first image object region and the second image object region based on pixel information on the pixels and predetermined region-determining conditions, a division line is determined in the boundary region based on the values of the pixels that constitute the boundary region, and the boundary region is divided into the first image object region and the second image object region using the division line as a boundary.

Therefore, it is possible to clearly distinguish the first image object region from the second image object region in the boundary region that is the obscure portion between the image object regions, which cannot be distinguished by clear edges.

In the image processing method of a third aspect according to the second aspect of the present invention, pixels having intermediate values between the values of the pixels positioned along the boundary of the first image object region and the values of the pixels positioned along the boundary of the second image object region or values close to the intermediate values are selected as the division line in the boundary region so that the selected pixels are continuously arranged along the boundary.

Therefore, since it is possible to reduce the likelihood or prevent the division line from being formed in an unnatural position, it is possible to distinguish the first image object region from the second image object region with no sense of incongruity in the boundary region.

A fourth aspect of the present invention is an image processing method of synthesizing an arbitrary image object region in a target image composed of a set of a plurality of pixels with another background image, the arbitrary image object region being divided from another image object region adjacent to the image object through a boundary region together with the boundary region, based on pixel information on the pixels and predetermined region-determining conditions, the image object region being synthesized with another background image together with the boundary region, and the pixel values of a group of pixels that constitute the boundary region being controlled according to the pixel values of a group of pixels that constitute the background image.

Therefore, since it is possible to gradually change the pixel values from the image object region to the background image, it is possible to generate a synthesized image obtained by synthesizing the image object region with the background image with no sense of incongruity between the periphery of the image object region and the background image. Here, the pixel values of the group of pixels that constitute the boundary region or the background image are, for example, the RGB values, the CMYK values, and color coordinates, difference between luminance and color, and color, chroma, and brightness in calorimetric systems, such as CIELab and XYZ in the values that represent the colors of the pixels. The pixel values may include the transparency value in addition to the above-mentioned values (the same is true of the image processing apparatus and the image processing program).

According to a fifth aspect of the present invention, in the image processing method according to the fourth aspect, the pixel values of the group of pixels that constitute the boundary region are controlled so that the difference in the pixel values between the group of pixels that constitute the boundary region and the group of pixels that constitute the background image is gradually reduced toward the background image.

Therefore, since the pixel values gradually change from the image object region to the background image, it is possible to generate a synthesized image with no sense of incongruity between the periphery of the image object region and the background image.

According to a sixth aspect of the present invention, in the image processing method according to the fourth aspect, the transparencies of the pixel values of the group of pixels that constitute the boundary region are controlled to be gradually increased toward the background image.

Therefore, since the influences of the pixel values of the background image are gradually applied from the image object region to the background image, it is possible to generate a synthesized image with no sense of incongruity between the periphery of the image object region and the background image.

According to a seventh aspect of the present invention, in the image processing method according to any one of the first to sixth aspects, the predetermined region-determining conditions are the following conditions 1 to 3:

### CONDITION 1

The first group of pixels is a group of pixels in which the difference in the pixel values between adjacent pixels is smaller than a predetermined threshold value A, and which are continuously arranged in a predetermined direction from an attention pixel;

### CONDITION 2

The group of boundary pixels is a group of pixels in which the difference in the pixel values between adjacent pixels is equal to or larger than the predetermined threshold value A and the difference in the changes in the pixel values between the adjacent pixels is smaller than a predetermined threshold value B, and which are continuously arranged in the predetermined direction from the first group of pixels; and

### CONDITION 3

The second group of pixels is a group of pixels in which the difference in the pixel values between adjacent pixels is smaller than the predetermined threshold value A and the difference in the pixel values between the first group of pixels and the second group of pixels is equal to or larger than a predetermined threshold value C, and which are continuously arranged in the predetermined direction from the group of boundary pixels.

Therefore, it is possible to detect the pixels that belong to the first group of images, the second group of images, and the group of boundary images. Furthermore, it is possible to distinguish the image object region from the boundary region by detecting the first group of images, the second group of images, and the group of boundary images.

An eighth aspect of the present invention is an image processing apparatus to detect a target image composed of a set of a plurality of pixels in each of a plurality of image object regions, the image processing apparatus including: a boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region, based on pixel information on the pixels and predetermined region-determining conditions.

Therefore, as in the first aspect of the present invention, since it is possible to detect the obscure portion between the image object regions, which cannot be distinguished by clear edges, as the boundary region that is an independent region, it is possible to distinguish the target image as one image region composed of the image object region and the boundary region.

A ninth aspect of the present invention is an image processing apparatus to divide a target image composed of a set of a plurality of pixels in each of a plurality of image object regions, the image processing apparatus including: a boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions; and a boundary region dividing device to determine a division line in the boundary region based on the values of the pixels that constitute the boundary region, and to divide the boundary region into the first image object region and the second image object region using the division line as a boundary.

Therefore, as in the second aspect of the present invention, it is possible to clearly distinguish the first image object region from the second object region in the boundary region that is the obscure portion between the image object regions, which cannot be distinguished by clear edges.

According to a tenth aspect of the present invention, in the image processing apparatus according to the ninth aspect, pixels having intermediate values between the values of the pixels positioned along the boundary of the first image object region and the values of the pixels positioned along the boundary of the second image object region or values close to the intermediate values are selected by the division line in the boundary region, which is determined by the boundary region dividing device, and the selected pixels are used as a line continuously arranged along the boundary.

Therefore, as in the third aspect of the present invention, since it is possible to reduce the likelihood or prevent the division line from being formed in an unnatural position, it is possible to distinguish the first image object region from the second image object region with no sense of incongruity in the boundary region.

An eleventh aspect of the present invention is an image processing apparatus to synthesize an arbitrary image object region in a target image composed of a set of a plurality of pixels with another background image, the image processing apparatus including: an image object dividing device to divide the arbitrary image object region from another image object region adjacent to the image object with a boundary region together with the boundary region, based on pixel information on the pixels and predetermined region-determining conditions; and a pixel value controlling device to synthesize the image object region with another background image together with the boundary region and to control the pixel values of a group of pixels that constitute the boundary region according to the pixel values of a group of pixels that constitute the background image.

Therefore, as in the fourth aspect of the present invention, since it is possible to gradually change the pixel values from the image object region to the background image, it is possible to generate a synthesized image obtained by synthesizing the image object region with the background image with no sense of incongruity between the periphery of the image object region and the background image.

According to a twelfth aspect of the present invention, in the image processing apparatus according to the eleventh aspect, the pixel value controlling device controls the pixel values of the group of pixels that constitute the boundary region such that the difference in the pixel values between the group of pixels that constitute the boundary region and the group of pixels that constitute the background image is gradually reduced toward the background image.

Therefore, as in the fifth aspect of the present invention, since the pixel values gradually change from the image object region to the background image, it is possible to generate a synthesized image with no sense of incongruity between the periphery of the image object region and the background image.

According to a thirteenth aspect of the present invention, in the image processing apparatus according to the eleventh aspect, the pixel value controlling device controls the transparencies of the pixel values of the group of pixels that constitute the boundary region so as to be gradually increased toward the background image.

Therefore, as in the sixth aspect of the present invention, since the influences of the pixel values of the background image are gradually applied from the image object region to the background image, it is possible to generate a synthesized image with no sense of incongruity between the periphery of the image object region and the background image.

A fourteenth aspect of the present invention is an image processing apparatus to detect a target image composed of a set of a plurality of pixels in each of a plurality of image object regions and to divide the image object regions to thus synthesize the divided image object regions with other background images, the image processing apparatus including: a boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region, based on pixel information on the pixels and predetermined region-determining conditions; and a region information generating device to divide any one of the first image object region and the second image object region together with the boundary region to thus synthesize the divided image object region and boundary region with the background image and to control the pixel values of the group of pixels that constitute the boundary region according to the pixel values of the group of pixels that constitute the background image.

Therefore, as in the second aspect of the present invention, it is possible to clearly distinguish the first image object region from the second image object region in the boundary region that is the obscure portion between the image object regions, which cannot be distinguished by clear edges.

A fifteenth aspect of the present invention is an image processing program to detect a target image composed of a set of a plurality of pixels in each of a plurality of image object regions, wherein the program making a computer function as boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions.

Therefore, as in the second aspect of the present invention, it is possible to clearly distinguish the first image object region from the second image object region in the boundary region that is the obscure portion between the image object regions, which cannot be distinguished by clear edges. Also, since a general purpose computer, such as a PC can be used as it is, it is possible to more easily and economically realize the present invention than when the present invention is realized by establishing exclusive use hardware. Furthermore, it is possible to easily enhance the performance of the image processing program by modifying only a part of the image processing program.

A sixteenth aspect of the present invention is an image processing program to divide a target image composed of a set of a plurality of pixels into each of a plurality of image object regions, the program including: a boundary region detecting device to detect when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions; and a boundary region dividing device to determine a division line in the boundary region based on the values of the pixels that constitute the boundary region, and to divide the boundary region into the first image object region and the second image object region using the division line as a boundary.

Therefore, as in the second aspect of the present invention, it is possible to clearly distinguish the first image object region from the second image object region in the boundary region that is the obscure portion between the image object regions, which cannot be distinguished by clear edges. Also, as in the fifteenth aspect of the present invention, it is possible to more easily and economically realize the present invention.

According to a seventeenth aspect of the present invention, in the image processing program according to the sixteenth aspect, pixels having intermediate values between the values of the pixels positioned along the boundary of the first image object region and the values of the pixels positioned along the boundary of the second image object region or values close to the intermediate values, are selected by the division line in the boundary region, which is determined by the boundary region dividing device, and the selected pixels are used as a line continuously arranged along the boundary.

Therefore, as in the third aspect of the present invention, since it is possible to reduce the likelihood or prevent the division line from being formed in an unnatural position, it is possible to distinguish the first image object region from the second image object region with no sense of incongruity in the boundary region. Also, as in the fifteenth aspect of the present invention, it is possible to more easily and economically realize the present invention.

An eighteenth aspect of the present invention is an image processing program to synthesize an arbitrary image object region in a target image composed of a set of a plurality of pixels with another background image, the image processing program including: an image object dividing device to divide the arbitrary image object region from another image object region adjacent to the image object through a boundary region together with the boundary region; and pixel value controlling device to synthesize the image object region with another background image together with the boundary region and to control the pixel values of a group of pixels that constitute the boundary region according to the pixel values of a group of pixels that constitute the background image.

Therefore, as in the fourth aspect of the present invention, since it is possible to gradually change the pixel values from the image object region to the background image, it is possible to generate a synthesized image obtained by synthesizing the image object region with the background image with no sense of incongruity between the periphery of the image object region and the background image. Also, as in the fifteenth aspect of the present invention, it is possible to more easily and economically realize the present invention.

According to a nineteenth aspect of the present invention, in the image processing program according to the eighteenth aspect, the pixel value controlling device controls the pixel values of the group of pixels that constitute the boundary region such that the difference in the pixel values between the group of pixels that constitute the boundary region and the group of pixels that constitute the background image is gradually reduced toward the background image.

Therefore, as in the fifth aspect of the present invention, since the pixel values gradually change from the image object region to the background image, it is possible to generate a synthesized image with no sense of incongruity between the periphery of the image object region and the background image. Also, as in the fifteenth aspect of the present invention, it is possible to more easily and economically realize the present invention.

According to a twentieth aspect of the present invention, in the image processing program according to the eighteenth aspect, the pixel value controlling device controls the transparencies of the pixel values of the group of pixels that constitute the boundary region so as to be gradually increased toward the background image.

Therefore, as in the sixth aspect of the present invention, since the influences of the pixel values of the background image are gradually applied from the image object region to the background image, it is possible to generate a synthesized image with no sense of incongruity between the periphery of the image object region and the background image. Also, as in the fifteenth aspect of the present invention, it is possible to more easily and economically realize the present invention.

A twenty-first aspect of the present invention is an image processing program to detect a target image composed of a set of a plurality of pixels in each of a plurality of image object regions and to divide the image object regions to thus synthesize the divided image object regions with other background images, a computer operating the following devices: a boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions; and a region information generating device to divide any one of the first image object region and the second image object region together with the boundary region to thus synthesize the divided image object region and boundary region with the background image and to control the pixel values of the group of pixels that constitute the boundary region according to the pixel values of the group of pixels that constitute the background image.

Therefore, as in the second aspect of the present invention, it is possible to clearly distinguish the first image object region from the second image object region in the boundary region that is the obscure portion between the image object regions, which cannot be distinguished by clear edges. Also, as in the fifteenth aspect of the present invention, it is possible to more easily and economically realize the present invention.

A twenty-second aspect of the present invention is an image processing apparatus to divide a target image composed of a plurality of pixels into a plurality of image object regions based on pixel information on the pixels, wherein, when one of adjacent image object regions is a first image object region and the other image object region is a second image object region, in a group of pixels continuously arranged in a predetermined direction and existing on the boundary between the first image object region and the second image object region and in the vicinity of the boundary, the group of pixels composed of the pixels having intermediate characteristics between the characteristics of the first image object region and the characteristics of the second object region is detected as a boundary region between the first image object region and the second image object region based on predetermined region-determining conditions.

Therefore, even when the image object region in the target image is not distinguished by clear edges and generates a boundary region of small width, it is possible to detect the boundary region identified as an image region. Also, it is possible to distinguish the detected boundary region as an image region different from the image object region.

According to a twenty-third aspect of the present invention, the image processing apparatus according to the twenty-second aspect includes an image change detecting device to detect the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and to identify them by region properties; image change information storing device to store the region properties of the pixels detected by the image change detecting device in a predetermined storage unit as the pixel information on the pixels; a closed region detecting device to detect a group of pixels composed of continuous pixels having the same region properties as a closed region based on the region properties of the pixels stored by the image change information storing device; and a region information outputting device to output region information to identify the boundary region or the image object region to which the closed region detected by the closed region detecting device belongs.

Therefore, even when the image object region in the target image is not distinguished by clear edges and generates the boundary region of small width, it is possible to detect the boundary region identified as an image region. Also, it is possible to distinguish the detected boundary region as an image region different from the image object region.

According to a twenty-fourth aspect of the present invention, in the image processing apparatus according to the twenty-third aspect, the predetermined region-determining conditions are as follows:

### CONDITION 1

The first group of pixels is a group of pixels in which the difference in the pixel values between adjacent pixels is smaller than a predetermined threshold value A, and which is continuously arranged in a predetermined direction from an attention pixel;

### CONDITION 2

The group of boundary pixels is a group of pixels in which the difference in the pixel values between adjacent pixels is equal to or larger than the predetermined threshold value A and the difference in the changes in the pixel values between the adjacent pixels is smaller than a predetermined threshold value B, and which are continuously arranged in the predetermined direction from the first group of pixels; and

### CONDITION 3

The second group of pixels is a group of pixels in which the difference in the pixel values between adjacent pixels is smaller than the predetermined threshold value A and the difference in the pixel values between the first group of pixels and the second group of pixels is equal to or larger than a predetermined threshold value C, and which are continuously arranged in the predetermined direction from the group of boundary pixels.

Therefore, it is possible to detect the pixels belong to the first group of images, the second group of images, and the group of boundary images. Furthermore, it is possible to distinguish the image object region from the boundary region by detecting the first group of images, the second group of images, and the group of boundary images.

According to a twenty-fifth aspect of the present invention, in the image processing apparatus according to the twenty-third aspect or the twenty-fourth aspect, the predetermined directions are at least two different directions among the directions of the lines that link the center of an attention pixel to the centers of the pixels that contact the attention pixel.

Therefore, it is possible to distinguish the object region as an image region having two-dimensional enlargement.

According to a twenty-sixth aspect of the present invention, the image processing apparatus according to any one of the twenty-second to twenty-fifth aspects further includes a boundary region processing device to divide the boundary region between the detected first image object region and second image object region into two divided boundary regions based on predetermined boundary region dividing conditions and to determine to which region each of the divided boundary regions belongs between the first image object region and the second object region.

Therefore, it is possible to determine a boundary between adjacent image object regions by using a boundary line to distinguish a boundary region by predetermined boundary region distinguishing conditions as the boundary between the image object regions, which cannot be distinguished by clear edges. Therefore, it is possible to distinguish even an object region whose edges cannot be determined as an image object region.

According to a twenty-seventh aspect of the present invention, the image processing apparatus according to any one of the twenty-second to twenty-sixth aspects may include an image inputting device to input image information on the target image, to generate the pixel information on the pixels that constitute the target image, which is required to divide the target image into the image regions, and to store the pixel information in a predetermined storage unit. In this way, an image process can be performed regardless of the form of image information on the target image to be processed.

According to a twenty-eight aspect of the present invention, the image processing apparatus according to any one of the twenty-second to twenty-seventh aspects may include a condition determining device to determine the predetermined region-determining conditions and to store the predetermined region-determining conditions in a predetermined storage unit.

Therefore, it is possible to determine the optimal region dividing conditions to divide the target image into the image object regions and the boundary regions.

A twenty-ninth aspect according to the present invention is an image processing method of dividing a target image composed of a plurality of pixels into a plurality of image regions based on pixel information on the pixels, wherein, when one of adjacent image object regions is a first image object region and the other image object region is a second image object region, in a group of pixels continuously arranged in a predetermined direction and existing on the boundary between the first image object region and the second image object region and in the vicinity of the boundary, the group of pixels composed of the pixels having intermediate characteristics between the characteristics of the first image object region and the characteristics of the second object region is detected as a boundary region between the first image object region and the second image object region based on predetermined region-determining conditions.

Therefore, even when the image object in the target image is not distinguished by clear edges and generates the boundary a small width, it is possible to detect the boundary region identified as an image region. Also, it is possible to distinguish the detected boundary region as an image region different from the image object region.

According to a thirtieth aspect of the present invention, the image processing method according to the twenty-ninth aspect includes: (a) an image change detecting step of detecting the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and of identifying them by region properties; (b) an image change information storing step of storing the region properties of the pixels detected by the image change detecting step in a predetermined storage unit as the pixel information on the pixels; (c) a closed region detecting step of detecting a group of pixels composed of continuous pixels having the same region properties as a closed region, based on the region properties of the pixels stored in the image change information storing step; and (d) a region information outputting step of outputting region information to identify the boundary region or the image object region to which the closed region detected in the closed region detecting step belongs.

Therefore, even when the image object in the target image is not distinguished by clear edges and generates the boundary with a small width, it is possible to detect the boundary region identified as an image region. Also, it is possible to distinguish the detected boundary region as an image region different from the image object region.

According to a thirty-first aspect of the present invention, the image processing method according to the thirtieth aspect includes, between the closed region detecting step (c) and the region information outputting step (d), (e) a boundary region processing step of dividing the boundary region between the first image object region and the second object region, which is detected in the image change detecting step, into two divided boundary regions based on predetermined boundary region dividing conditions and of determining to which region each of the divided boundary regions belongs, between the first image object region and the second object region.

Therefore, it is possible to determine a boundary between adjacent image object regions by using a boundary line to distinguish a boundary region by predetermined boundary region distinguishing conditions as the boundary between the image object regions, which cannot be distinguished by clear edges. Therefore, it is possible to distinguish even an object region whose edges cannot be determined as an image object region.

A thirty-second aspect of the present invention is an image processing program that divides a target image composed of a plurality of images into a plurality of image regions based on pixel information on the pixels and that is executable by a computer, the computer executing a step in which, when one of adjacent image object regions is a first image object region and the other image object region is a second image object region, in a group of pixels continuously arranged in a predetermined direction and existing on the boundary between the first image object region and the second image object region and in the vicinity of the boundary, the group of pixels composed of the pixels having intermediate characteristics between the characteristics of the first image object region and the characteristics of the second object region is detected as a boundary region between the first image object region and the second image object region, based on predetermined region-determining conditions.

Therefore, even when the image object in the target image is not distinguished by clear edges and generates the boundary with a small width, it is possible to detect the boundary region identified as an image region. Also, it is possible to distinguish the detected boundary region as an image region different from the image object region.

According to a thirty-third aspect of the present invention, the image processing program according to the thirty-second aspect executes an image processing method including: (a) an image change detecting step of detecting the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and of identifying them by region properties; (b) an image change information storing step of storing the region properties of the pixels detected in the image change detecting step in a predetermined storage unit as the pixel information on the pixels; (c) a closed region detecting step of detecting a group of pixels composed of continuous pixels having the same region properties as a closed region, based on the region properties of the pixels stored in the image change information storing step; (d) a region information outputting step of outputting region information to identify the boundary region or the image object region to which the closed region detected in the closed region detecting step belongs; and (e) a boundary region processing step of dividing the boundary region between the first image object region and the second object region, which is detected in the image change detecting step, into two divided boundary regions based on predetermined boundary region dividing conditions and of determining to which region each of the divided boundary regions belongs between the first image object region and the second object region.

Therefore, even when the image object in the target image is not distinguished by clear edges and generates the boundary with small width, it is possible to detect the boundary region identified as an image region. Also, it is possible to distinguish the detected boundary region as an image region different from the image object region. Furthermore, it is possible to determine a boundary between adjacent image object regions by using a boundary line to distinguish a boundary region by predetermined boundary region distinguishing conditions as the boundary between the image object regions, which cannot be distinguished by clear edges. Therefore, it is possible to distinguish even an object region whose edges cannot be determined as an image object region.

A thirty-fourth aspect of the present invention is an image processing apparatus to divide the image information of a target image composed of a plurality of pixels into a plurality of image object regions based on pixel information on the pixels, wherein, when an arbitrary image object region of the target image is used as a target image object region and the image object region in the target image, which is adjacent to the target image object region, is used as an adjacent image object region, in a group of pixels existing on the boundary between the target image object region and the adjacent image object region and in the vicinity of the boundary, the pixel information on the pixels that belong to a region corresponding to the group of pixels is generated based on the changes in the characteristics of the pixels in the predetermined directions in the group of pixels composed of the pixels having intermediate characteristics between the characteristics of the target image object region and the characteristics of the adjacent image object region.

Therefore, even when the image object in the target image is not distinguished by clear edges and generates the boundary with a small width, it is possible to detect the boundary region identified as an image region. Also, it is possible to distinguish the detected boundary region as an image region different from the image object region.

Also, when a synthesized image is generated by synthesizing the target image object region and the boundary region with the background image, it is possible to generate the synthesized image with no sense of incongruity around the target image object region by appropriately mixing the image information on the boundary region with the image information on the background image. In addition, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a thirty-fifth aspect of the present invention, the image processing apparatus according to the thirty-fourth aspect includes: a boundary region detecting device to detect, as a boundary region, the group of pixels composed of the pixels having the intermediate characteristics between the characteristics of the target image object region and the characteristics of the adjacent image object region in the group of pixels continuously arranged in a predetermined direction and existing in the vicinity of the boundary between the target image object region and the adjacent image object region, based on predetermined region-determining conditions; and a region information generating device to generate the pixel information on the pixels that belong to the boundary region, based on the changes in the characteristics of the pixels from the pixels that contact the target image object region to the pixels that contact the adjacent image object region out of the pixels that belong to the boundary region.

Therefore, even when the image object in the target image is not distinguished by clear edges and generates the boundary with small width, it is possible to detect the boundary region identified as an image region. Also, it is possible to distinguish the detected boundary region as an image region different from the image object region.

In addition, when a synthesized image is generated by synthesizing the target image object region and the boundary region with the background image, it is possible to generate the synthesized image with no sense of incongruity around the target image object region by appropriately mixing the image information on the boundary region with the image information on the background image. Furthermore, even when the synthesized image generating step is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a thirty-sixth aspect of the present invention, in the image processing apparatus according to the thirty-fifth aspect, the region information generating device includes a transparency calculating device to calculate the transparencies of all of the pixels from the pixels in the boundary region adjacent to the target image object region to the pixels in the boundary region adjacent to the adjacent image object region in the pixels continuously arranged in a direction orthogonal to the boundary line between the target image object region and the boundary region, based on the ratio of the changes in the characteristics of the pixels from the pixels that contact the target image object region to the pixels that contact the adjacent image object region.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a thirty-seventh aspect of the present invention, in the image processing apparatus according to the thirty-fifth aspect, the region information generating device may include a synthesized image information generating device to update the pixel information on the pixels that belong to the boundary region to information suitable for the background image to generate the pixel information on a synthesized image, based on the image information on the background image adjacent to the boundary region and the transparencies calculated by the transparency calculating device, in the synthesized image obtained by synthesizing the group of pixels of the target image object region and the boundary region with the background image.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image.

According to a thirty-eighth aspect of the present invention, the image processing apparatus according to the thirty-fifth aspect includes a region information outputting device to add the transparencies calculated by the transparency calculating device to the region information on the image object region and the pixel information on the pixels that belong to the boundary region as transparency information, and to output the added information as region information on the image object region.

Therefore, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a thirty-ninth aspect of the present invention, the image processing apparatus according to the thirty-seventh aspect includes a synthesized image information outputting device to output pixel information on the synthesized image generated by the synthesized image information generating device.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image.

According to a fortieth aspect of the present invention, in the image processing apparatus according to the thirty-fifth aspect, the boundary region detecting device includes: an image change detecting device to detect the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and for identifying them by region properties; an image change information storing device to store the region properties of the pixels detected by the image change detecting device in a predetermined storage unit as the pixel information on the pixels; and a closed region detecting device to detect a group of pixels composed of continuous pixels having the same region properties as a closed region based on the region properties of the pixels stored by the image change information storing device.

Therefore, even when the image object in the target image is not distinguished by clear edges and generates the boundary with a small width, it is possible to detect the boundary region identified as an image region. Also, it is possible to identify the detected boundary region as an image region different from the image object region.

According to a forty-first aspect of the present invention, the image processing apparatus according to any one of the thirty-fifth to fortieth aspects includes a condition determining device to determine the predetermined region-determining conditions and to store the determined region-determining conditions in a predetermined storage unit.

Therefore, it is possible to determine the optimal region dividing conditions to divide the target image into the image object region and the boundary region.

According to a forty-second aspect of the present invention, the image processing apparatus according to any one of the thirty-fourth to forty-first aspects includes an image inputting device to input the image information on the target image or the image information on the background image, generating the image information on the target image in a form of internal process, and storing the generated image information in a predetermined storage unit.

Therefore, it is possible to process images, even when any type of image information on the target image to be image processed is input.

A forty-third aspect of the present invention is an image processing method of dividing the image information of a target image composed of a plurality of pixels into a plurality of image object regions based on pixel information on the pixels, when an arbitrary image object region of the target image is used as a target image object region and the image object region in the target image, which is adjacent to the target image object region, is used as an adjacent image object region, in a group of pixels existing on the boundary between the target image object region and the adjacent image object region and in the vicinity of the boundary, the pixel information on the pixels that belong to a region corresponding to the group of pixels is generated based on the changes in the characteristics of the pixels in the predetermined directions in the group of pixels composed of the pixels having intermediate characteristics between the characteristics of the target image object region and the characteristics of the adjacent image object region.

Therefore, even when the image object in the target image is not distinguished by clear edges and generates the boundary with a small width, it is possible to detect the boundary region identified as an image region. Also, it is possible to distinguish the detected boundary region as an image region different from the image object region.

In addition, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a forty-fourth aspect of the present invention, the image processing method according to the forty-third aspect includes: (a) a boundary region detecting step of detecting the group of pixels composed of the pixels having the intermediate characteristics between the characteristics of the target image object region and the characteristics of the adjacent object region as a boundary region, based on predetermined region-determining conditions, in the group of pixels continuously arranged in a predetermined direction around the boundary between the target image object region and the adjacent image object region; and (b) a region information generating step of generating the pixel information on the pixels that belong to the boundary region, based on the changes in the characteristics of the pixels from the pixels that contact the target image object region to the pixels that contact the adjacent image object region out of the pixels that belong to the boundary region.

Therefore, even when the image object in the target image is not distinguished by clear edges and generates the boundary with a small width, it is possible to detect the boundary region identified as an image region. Also, it is possible to identify the detected boundary region as an image region different from the image object region.

In addition, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a forty-fifth aspect of the present invention, in the image processing method according to the forty-fourth aspect, the region information generating step (b) includes a transparency calculating step of calculating the transparencies of all of the pixels from the pixels of the boundary region adjacent to the target image object region to the pixels of the boundary region adjacent to the adjacent image object region in the pixels continuously arranged in a direction orthogonal to the boundary line between the target image object region and the boundary region, based on the ratio of the changes in the characteristics from the pixels that contact the target image object region to the pixels that contact the adjacent image object region.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a forty-sixth aspect of the present invention, in the image processing method according to the forty-fifth aspect, the region information generating step (b) may include an image information generating step of updating the pixel information on the pixels that belong to the boundary region to information suitable for the background image and of generating the pixel information on a synthesized image, based on the image information on the background image adjacent to the boundary region and the transparencies calculated in the transparency calculating step, in the synthesized image obtained by synthesizing the group of pixels of the target image object region and the boundary region with the background image.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image.

According to a forty-seventh aspect of the present invention, the image processing method according to the forty-fifth aspect includes a region information outputting step of adding the transparencies calculated in the transparency calculating step to the region information on the image object region and the pixel information on the pixels that belong to the boundary region as transparency information and of outputting the added information as region information on the image object region.

Therefore, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a forty-eighth aspect of the present invention, the image processing method according to the forty-sixth aspect includes a synthesized image information outputting step of outputting image information on the synthesized image generated in the synthesized image information generating step.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image.

A forty-ninth aspect of the present invention is an image processing program that divides a target image composed of a plurality of pixels into a plurality of image object regions based on pixel information on the pixels and that is executable by a computer, wherein the computer executing a step in which, when an arbitrary image object region of the target image is used as a target image object region and the image object region of the target image, which is adjacent to the target image object region, is used as an adjacent image object region, in a group of pixels existing on the boundary between the target image object region and the adjacent image object region and in the vicinity of the boundary, the pixel information on the pixels that belong to a region corresponding to the group of pixels is generated based on the changes in the characteristics of the pixels in predetermined directions in the group of pixels composed of the pixels having intermediate characteristics between the characteristics of the target image object region and the characteristics of the adjacent image object region.

Therefore, even when the image object in the target image is not distinguished by clear edges and generates the boundary with a small width, it is possible to detect the boundary region identified as an image region. Also, it is possible to identify the detected boundary region as an image region different from the image object region.

In addition, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a fiftieth aspect of the present invention, in the image processing program according to the forty-ninth aspect, the computer executes an image processing method including: (a) a boundary region detecting step of detecting the group of pixels composed of the pixels having the intermediate characteristics between the characteristics of the target image object region and the characteristics of the adjacent object region as a boundary region, based on predetermined region-determining conditions, in the group of pixels continuously arranged in a predetermined direction around the boundary between the target image object region and the adjacent image object region; and (b) a region information generating step of generating the pixel information on the pixels that belong to the boundary region in the synthesized image generated by synthesizing the target image object region and the boundary region with the background image, based on the changes in the characteristics of the pixels from the pixels that contact the target image object region to the pixels that contact the adjacent image object region out of the pixels that belong to the boundary region.

Therefore, even when the image object in the target image is not distinguished by clear edges and generates the boundary with a small width, it is possible to detect the boundary region identified as an image region. Also, it is possible to distinguish the detected boundary region as an image region different from the image object region.

In addition, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a fifty-first aspect of the present invention, in the image processing program for making a computer execute each step of an image processing method according to the fiftieth aspect, the region information generating step (b) including a transparency calculating step of calculating the transparencies of all of the pixels from the pixels of the boundary region adjacent to the target image object region to the pixels of the boundary region adjacent to the adjacent image object region in the pixels continuously arranged in a direction orthogonal to the boundary line between the target image object region and the boundary region, based on the ratio of the changes in the characteristics of the pixels from the pixels that contact the target image object region to the pixels that contact the adjacent image object region.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image. Also, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a fifty-second aspect of the present invention, in the image processing program to make a computer execute each step of an image processing method according to the fifty-first aspect, the region information generating step (b) may include an image information generating step of updating the pixel information on the pixels that belong to the boundary region to information suitable for the background image and of generating the pixel information on a synthesized image, based on the image information on the background image adjacent to the boundary region and the transparencies calculated in the transparency calculating device, in the synthesized image obtained by synthesizing the group of pixels of the target image object region and the boundary region with the background image.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image.

According to a fifty-third aspect of the present invention, in the image processing program to make a computer execute each step of an image processing method according to the fifty-first aspect, the image processing method includes a region information outputting step of adding the transparencies calculated in the transparency calculating step to the region information on the image object region and the pixel information on the pixels that belong to the boundary region as transparency information and of outputting the added information as region information on the image object region.

Therefore, even when the synthesized image generating process is performed by another apparatus, it is possible to generate a synthesized image with no sense of incongruity around the target image object region by adding the information obtained by removing the influences of the characteristics of an adjacent image object region from the image information on the boundary region to the pixel information on the pixels of the boundary region.

According to a fifty-fourth aspect of the present invention, in the image processing program to make a computer execute each step of an image processing method according to the fifty-second aspect, the image processing method includes a synthesized image information outputting step of outputting image information on the synthesized image generated in the synthesized image information generating step.

Therefore, when a synthesized image is generated by synthesizing the target image object region and the boundary region with the background image, it is possible to generate the synthesized image with no sense of incongruity around the target image object region by appropriately mixing the image information on the boundary region with the image information on the background image.

### BRIEF DESCRIPTION OF THE DRAWINGS

FIG. 1 is a schematic of an image processing apparatus according to a first exemplary embodiment of the present invention;

FIG. 2 is an example of a functional schematic of the image processing apparatus;

FIG. 3A is an example of a flow chart for an image process of dividing a target image into image regions composed of image object regions and boundary regions. FIG. 3B is an example of a flow chart for an image process when the target image is divided into image object regions;

FIG. 4 is a flow chart for an image change detecting process;

FIG. 5 is a flow chart for an image change detecting process continued from FIG. 4;

FIG. 6 is a flow chart for a determining process by boundary determining conditions;

FIG. 7 is a flow chart for a determining process by the boundary determining conditions, which are continued from FIG. 6;

FIG. 8 is a flow chart for a determining process by the boundary determining conditions continued from FIGS. 6 and 7;

FIG. 9A is a schematic of a target image divided into an image object region A, an image object region B, and a boundary region A-B. FIG. 9B is a schematic diagram of a target image divided into an image object region A and an image object region B;

FIG. 10A is a schematic illustrating an example of dividing a boundary region by the coordinates of the pixels that constitute the boundary region. FIG. 10B is a schematic illustrating an example of dividing the boundary region with reduced load. FIG. 10C is a schematic illustrating an example of dividing the boundary region by image information on the pixels that constitute the boundary region.

FIG. 11 is an example of a schematic of an image processing apparatus according to a second exemplary embodiment;

FIG. 12 is an example of a flow chart for an image process of dividing a target image into image regions composed of image object regions and boundary regions and of generating region information for synthesizing images;

FIG. 13 is a flow chart for an image change detecting process;

FIG. 14 is a flow chart for an image change detecting process continued from FIG. 13;

FIG. 15 is a flow chart for a transparency calculating process;

FIG. 16 is a flow chart for a synthesized image information generating process;

FIG. 17A is a schematic for illustrating the order of searching pixels whose transparencies are calculated in the boundary region. FIG. 17B is a view illustrating the changes in the pixel information on the pixels in the boundary region. FIG. 17C is a view illustrating the changes in the transparencies of the pixels in the boundary region;

FIG. 18A is a schematic view for illustrating the order of searching the pixels for controlling the pixel information by the background image. FIG. 18B is a schematic illustrating the changes in the pixel information on the pixels that belong to the boundary region by the background image;

FIG. 19A is a schematic of a target image divided into an image object region A, an image object region B, and a boundary region A-B. FIG. 19B is a schematic of a target image divided into an image object region A and an image object region B;

FIG. 20 is a schematic view illustrating bit map data of 3×3 pixels;

FIG. 21 is a flow chart for a synthesized image generating process by a related art edge determining process;

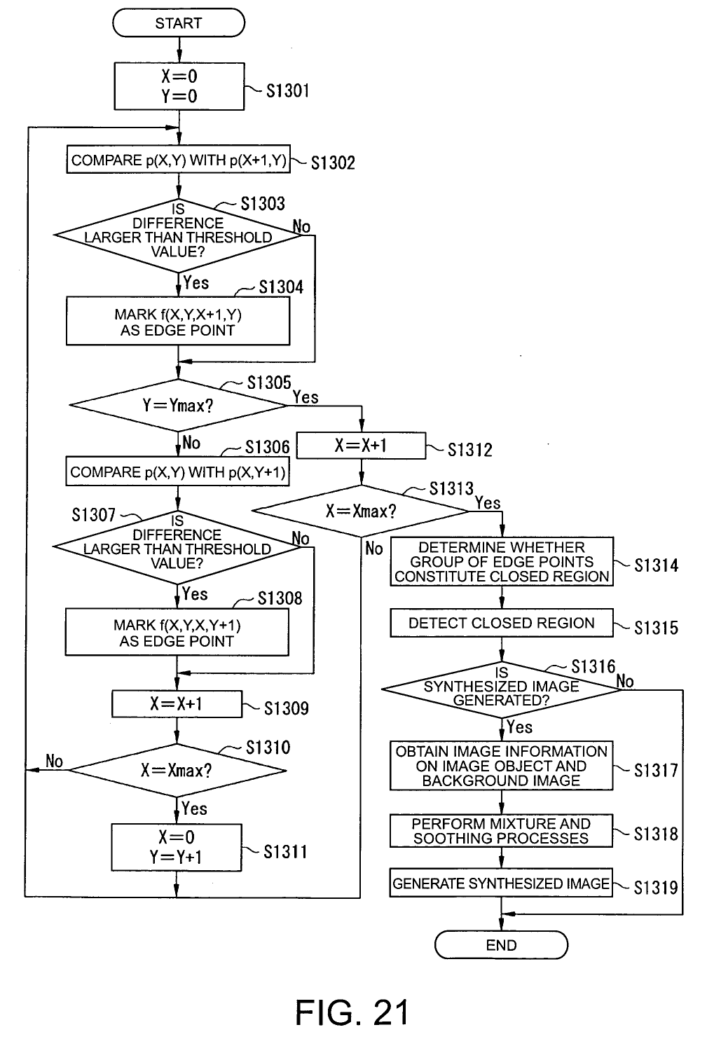

FIG. 22 is a schematic illustrating a boundary region simplified by bit map data of 3×6 pixels; and

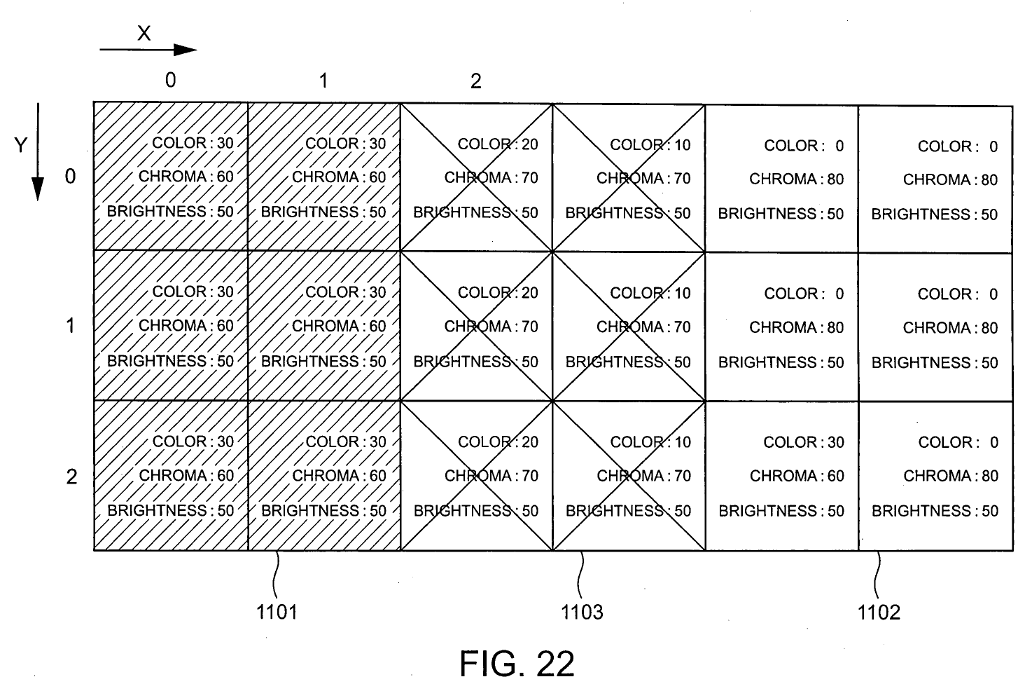

FIG. 23A is a schematic of a target image subjected to a related art edge determining process. FIG. 23B is a schematic view of a target image subjected to an edge determining process when an edge determining threshold value is too large. FIG. 23C is a schematic of a target image subjected to an edge determining process when the edge determining threshold value is too small.

### DETAILED DESCRIPTION OF EXEMPLARY EMBODIMENTS

Exemplary embodiments of the present invention will now be described in detail with reference to the accompanying drawings. A first exemplary embodiment mentioned hereinafter is for description and does not limit the scope of the present invention. Therefore, the skilled person in the art can employ exemplary embodiments in which other elements are substituted for each element or all elements of the first exemplary embodiment, and thus other exemplary embodiments are also included in the scope of the present invention.

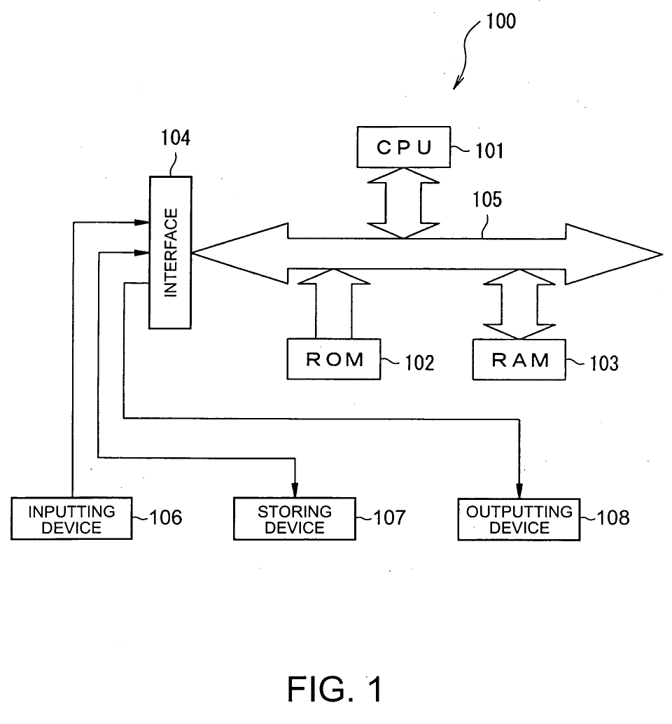

FIG. 1 is a block schematic of an image processing apparatus.

An image processing apparatus 100 includes a CPU 101 to control and operate all devices based on a control program, a ROM 102 to previously store the control program of the CPU 101 in a predetermined region, a RAM 103 to store the information read from the ROM 102 and the operation results required for the operation process of the CPU 101, and an interface 104 used as a medium of input and output of information into/from an external device. They are connected to each other by a bus 105, which is a signal line to transmit information, so as to receive information.

An input device 106, such as a keyboard or a mouse capable of inputting data from an external device, a storing device 107 to store image information on an image to be processed, and an output device 108 to output image processing results to a screen are connected to the interface 104.

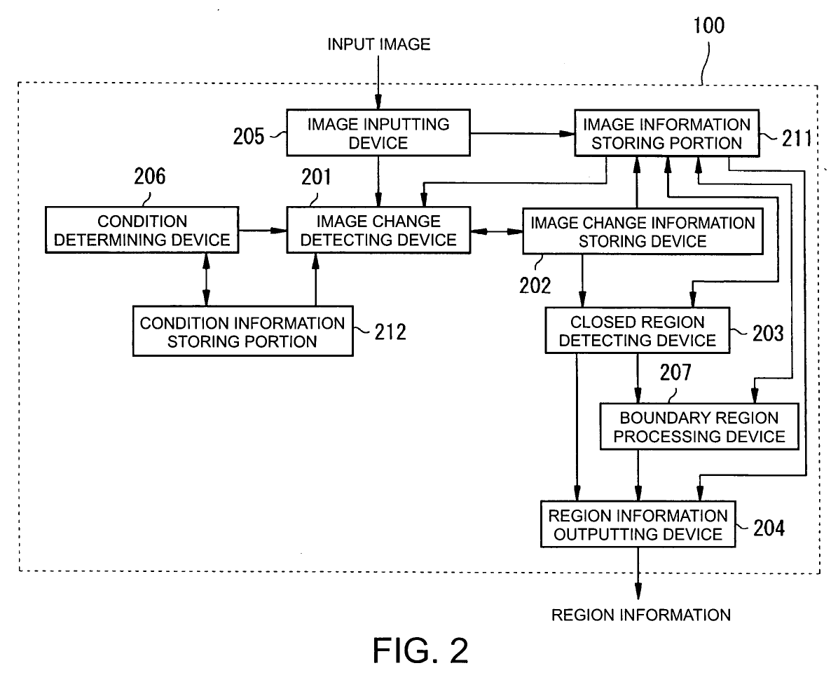

FIG. 2 is an example of a functional block schematic illustrating the image processing apparatus.

The image processing apparatus 100 includes an image change detecting device 201, an image change information storing device 202, a closed region detecting device 203, a region information outputting device 204, an image inputting device 205, and a condition setting device 206.

The image inputting device 205 inputs image information on a target image, obtains pixel information on each of the pixels that constitute the target image from the input image information, and stores the pixel information in an image information storing portion 211. The image inputting device 205 generates pixel information required for image processing, such as dividing an object region into image regions. For example, when the input image information is CMYK values and RGB values are required to divide the target image into the image regions, the image inputting device 205 generates the RGB values from the CMYK values and stores the generated RGB values in the image information storing portion 211 as pixel information.

The image change detecting device 201 detects a first group of pixels and a second group of pixels that belong to a first image object region and a second image object region that are two adjacent image object regions, respectively, and a group of boundary pixels interposed between the first group of pixels and the second group of pixels, based on the characteristics of a plurality of pixels continuously arranged in predetermined directions from an attention pixel and predetermined region-determining conditions. Here, the pixel characteristics are a color value, a chroma value, and a brightness value. The pixel characteristics are read from the image information storing portion 211. The region-determining conditions are read from the condition information storing portion 212. Furthermore, the region properties of the pixels that belong to each detected group of pixels are set. The pixels that belong to the first group of pixels determine the region properties to distinguish the first image object region. The pixels that belong to the second group of pixels determine the region properties to distinguish the second image object region. The pixels that belong to the group of boundary pixels determine the region properties to distinguish the boundary region.

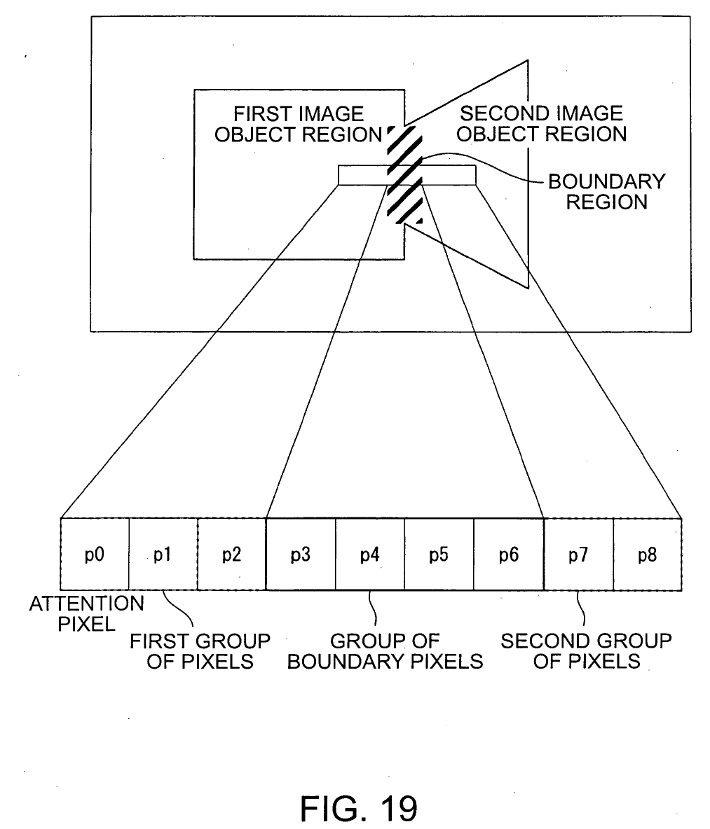

FIG. 19 is a schematic illustrating the first group of pixels, the second group of pixels, and the group of boundary pixels.

Pixels pi continuously arranged in a predetermined direction (for example, in the X-direction) from an attention pixel p0 are sequentially taken out. It is determined whether the sequentially taken pixels pi belong to the first group of pixels, the second group of pixels, or the group of boundary pixels based on the characteristics of the taken pixels pi, if necessary, the characteristics of the pixels pj to pi and predetermined region-determining conditions. The three region-determining conditions will now be described.

(CONDITION 1) The first group of pixels is continuously arranged in a predetermined direction from an attention pixel so that the difference in the characteristics between adjacent pixels is smaller than a predetermined threshold value A.

(CONDITION 2) The group of boundary pixels is continuously arranged in a predetermined direction from the first group of pixels so that the difference in the characteristics between adjacent pixels is equal to or larger than the predetermined threshold value A and the difference in the changes in the characteristics between adjacent pixels is smaller than a predetermined threshold value B.

(CONDITION 3) The second group of pixels is continuously arranged in a predetermined direction from the group of boundary pixels so that the difference in the characteristics between adjacent pixels is smaller than the predetermined threshold value A and the difference in the characteristics between the first group of pixels and the second group of pixels is equal to or larger than a predetermined threshold value C.

Here, the difference ci in the changes in the characteristics is the absolute value of the subtraction of the difference in the characteristics between a pixel pi−2 and a pixel pi−1 from the difference in the characteristics between the pixel pi−1 and a pixel pi. When the characteristics of the taken pixels pi are characteristics ai, the difference bi in the characteristics between adjacent pixels is bi=ai−ai−1. The difference ci in the changes is ci=|bi−bi−1. Also, the difference in the characteristics between the first group of pixels and the pixels pi is the absolute value of the subtraction of the typical characteristics of the first group of pixels from the characteristics of the pixels pi. When the typical characteristics of the first group of pixels are a0, the difference di in the characteristics between the pixels pi and the first group of pixels is di=|a0−ai |.

In FIG. 19, when the pixels are sequentially searched, the pixels that meet the condition 1 (bi<A) are the pixels p0 to p2. The pixels that meet the condition 2 {(bi>=A) and (bi+>=A)} and (ci<B) and (continuous arrangement in a predetermined direction from the pixel that meets the condition 1) are the pixels p3 to p6. The pixels that meet the condition 3 [{(bi>=A) and (bi+<A)} or (bi<A)]and (di>=C) and (continuous arrangement in a predetermined direction from the pixel that meets the condition 2) are the pixels p7 and p8. Therefore, the pixels p0, p1, and p2 are detected as the first group of pixels. The pixels p3, p4, p5, and p6 are detected as the group of boundary pixels. The pixels p7 and p8 are detected as the second group of pixels.

The image change information storing device 202 stores the region properties of the pixels detected by the image change detecting device 201 in the image information storing portion 211 as a part of the pixel information on the pixels.

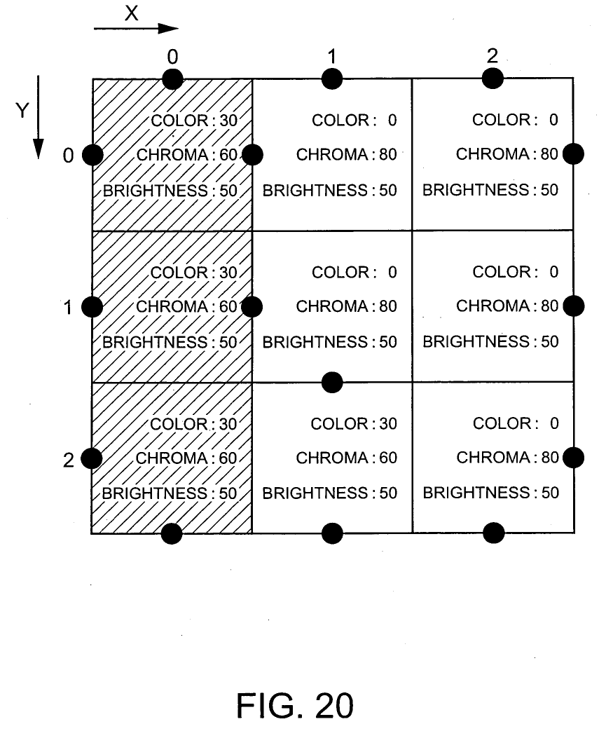

The closed region detecting device 203 reads the region properties of the pixels stored in the image information storing portion 211 and detects a group of continuous pixels that have the same region properties as a closed region. For example, in FIG. 20, the pixels that have the same region properties as those of the pixels that belong to the first group of pixels are detected. When a region composed of continuous pixels in the searched pixels is detected, the detected region is the closed region that is the same as the first pixel object region.

The region information output device 204 outputs region information to determine what image object region or what boundary region the closed region detected by the closed region detecting device 203 is.

The condition determining device 206 reads the information of determining the conditions used for the above-mentioned image change detecting device 201 to detect the region properties of the pixels from the condition information storing portion 212 and edits the read information or adds new information. For example, the condition determining device 206 can change values, such as the threshold values A, B, and C of the above-mentioned region condition information, store the changed values in the condition information storing portion 212, and add another condition as the condition 4.

The image processing apparatus 100 may further include boundary region processing device 207. The boundary region processing device 207 divides the boundary region interposed between two image object regions into two divided boundary regions, determines the image object regions to which the respective divided boundary regions belong and detects closed regions that are new image object regions that belong to the determined divided boundary regions. That is, the boundary region processing device 207 changes the region properties of the pixels that belong to the divided boundary regions so that the divided boundary regions can be distinguished from the image object regions to which the divided boundary regions belong and stores the changed region properties in the image information storing portion 211.

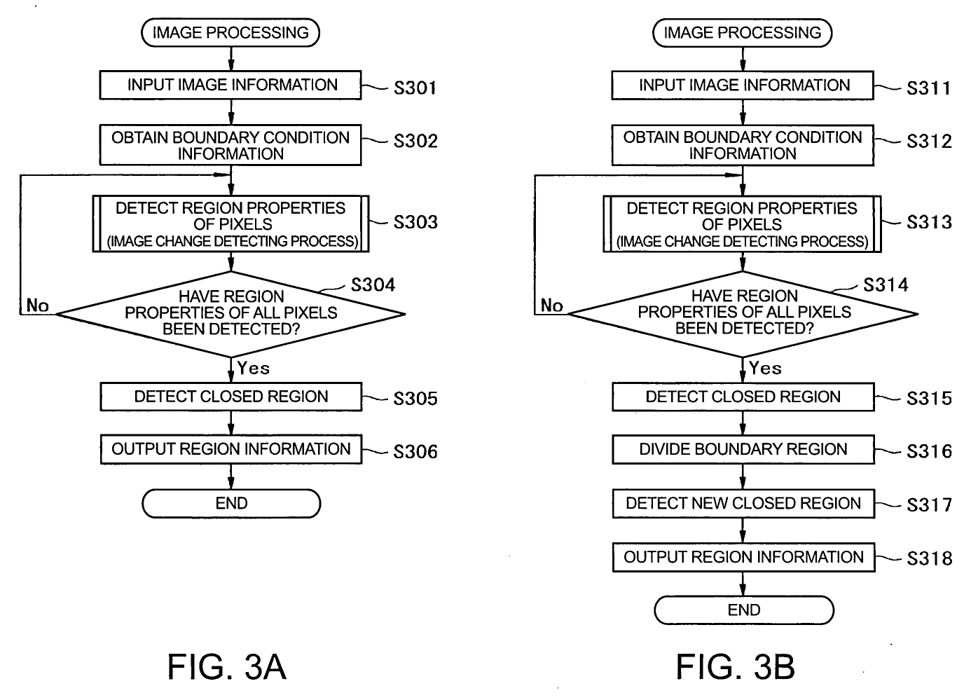

FIG. 3A is an example of a flow chart of an image process of dividing a target image into image regions composed of image object regions and boundary regions.

First, the image information on the target image to be image-processed is input and is stored in the image information storing portion 211 as pixel information on pixels (S301). Here, the pixel information required for subsequent image processing may be generated, if necessary. Then, boundary condition information to divide the target image into the image object regions or the boundary regions is read from the condition information storing portion 212 (S302).

Then, the first group of pixels and the second group of pixels that belong to the first image object region and the second image object region that are two adjacent image object regions, respectively, and the group of boundary pixels interposed between the first group of pixels and the second group of pixels are detected based on the characteristics of pixels continuously arranged in a predetermined direction from an attention pixel, and the boundary condition information read in the step S302. The region properties of the pixels that belong to each detected group of pixels are determined. The determined region properties of each group of pixels are stored in the image information storing portion 211 as a part of the pixel information on the pixels (S303).

Then, it is determined whether the region properties of all of the pixels that constitute the object region have been determined (S304). When it is determined that the region properties of all of the pixels have not been determined (S304: NO), step S303 is repeated until the region properties of all of the pixels are determined. When the region properties of all of the pixels have been determined (S304: YES), the region properties of the pixels, which are stored in the image information storing portion 211, are read. Continuous pixels that have the same region properties are searched to thus detect a closed region composed of the searched pixels. Region information to distinguish an image region that is the detected closed region is determined to thus store the determined region information in the image information storing portion 211 (S305). Finally, the region information on the divided image regions is read from the image information storing portion 211 and is output in accordance with an arbitrary output form (S306).

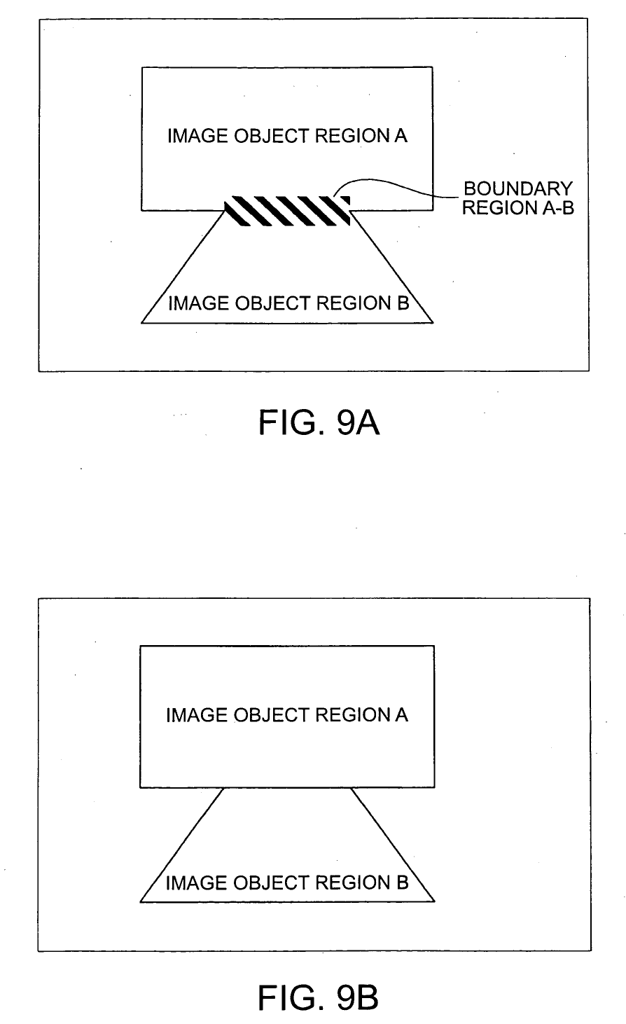

For example, when the target image illustrated in FIG. 24A is image-processed by the respective steps S301 to S306, the region properties of all of the pixels that constitute the target image are detected. Closed regions are detected by the detected region properties of the pixels. When the detected closed regions are distinguished by region-information, the target image illustrated in FIG. 9A is divided into an image object region A, an image object region B, and a boundary region A-B.

Also, in the above-mentioned image process of FIG. 3A, the boundary region is identified as an image region of the target image. However, the object region may be composed of an image object region. FIG. 3B is an example of a flowchart of image processing when the target image is composed of the image object region. Here, the descriptions of steps S311 to S315 will be omitted since steps S311 to S315 correspond to steps S301 to S305 of FIG. 3A, respectively.

The boundary region interposed between the two image object regions, which is searched in step S315, is divided into two divided boundary regions. Image object regions to which the respective divided boundary regions belong are determined (S316). Then, the region properties of the pixels that belong to the divided boundary regions are changed so that the divided boundary regions can be distinguished from the image object regions to which the divided boundary regions belong. The changed region properties are stored in the image information storing portion 211. Also, closed regions that are new image object regions to which the determined divided boundary regions belong, are detected. Region information to distinguish image regions that are the detected closed regions is determined to thus be stored in the image information storing portion 211 (S317). Finally, the region information on the divided image regions is read from the image information storing portion 211 and is output in accordance with an arbitrary output form (S318).

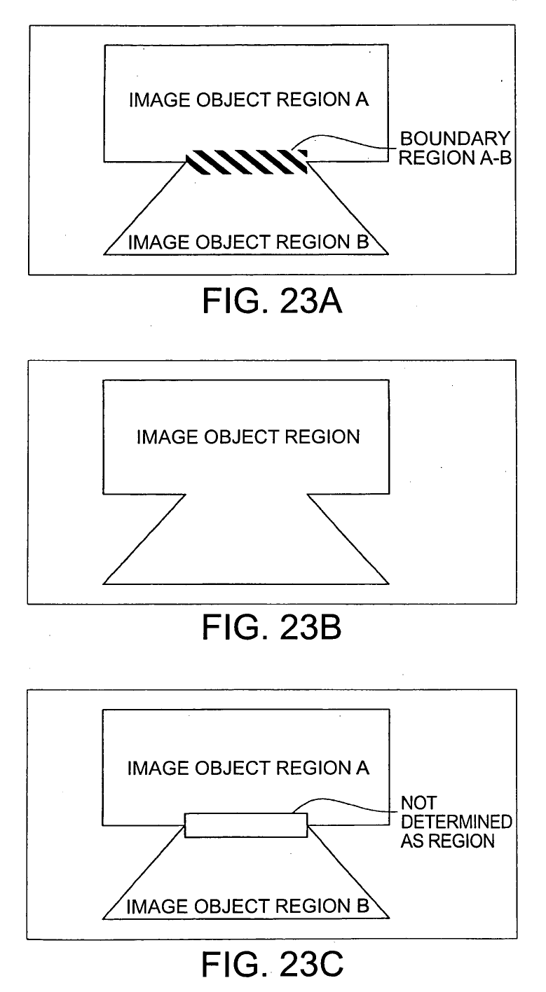

For example, when the target image illustrated in FIG. 23A is image-processed by the above-mentioned steps S311 to S318, the region properties of all of the pixels that constitute the target image are detected. Closed regions are detected by the detected region properties of the pixels. When the detected closed regions are distinguished by the region information, the target image illustrated in FIG. 9B is divided into an image object region A and an image object region B.

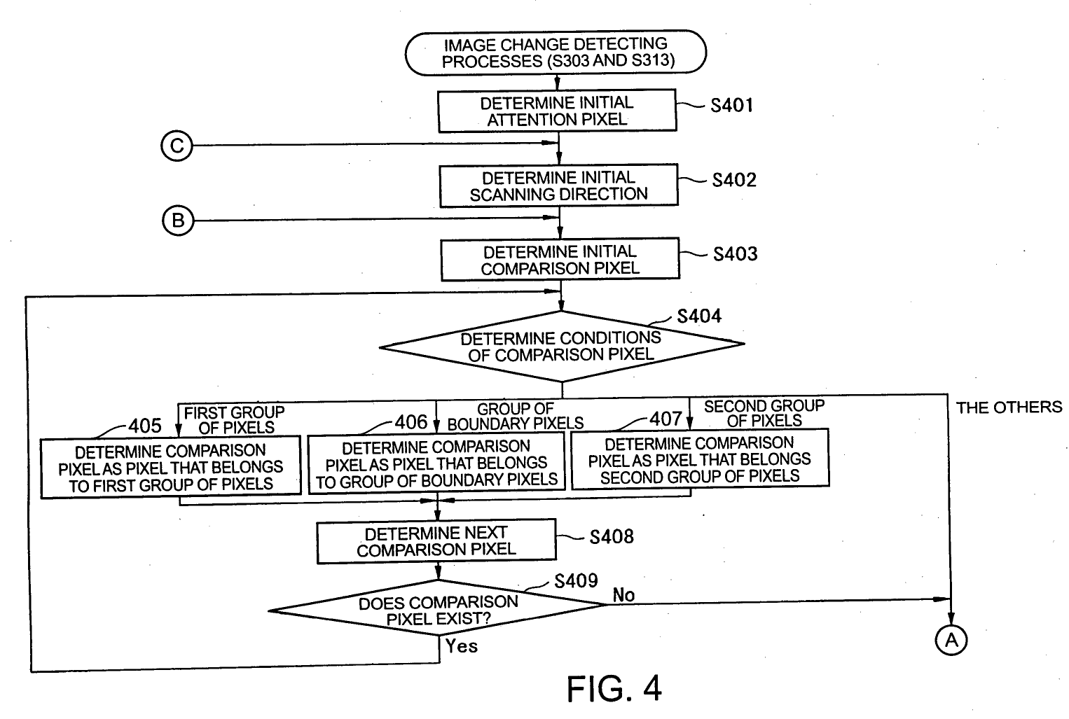

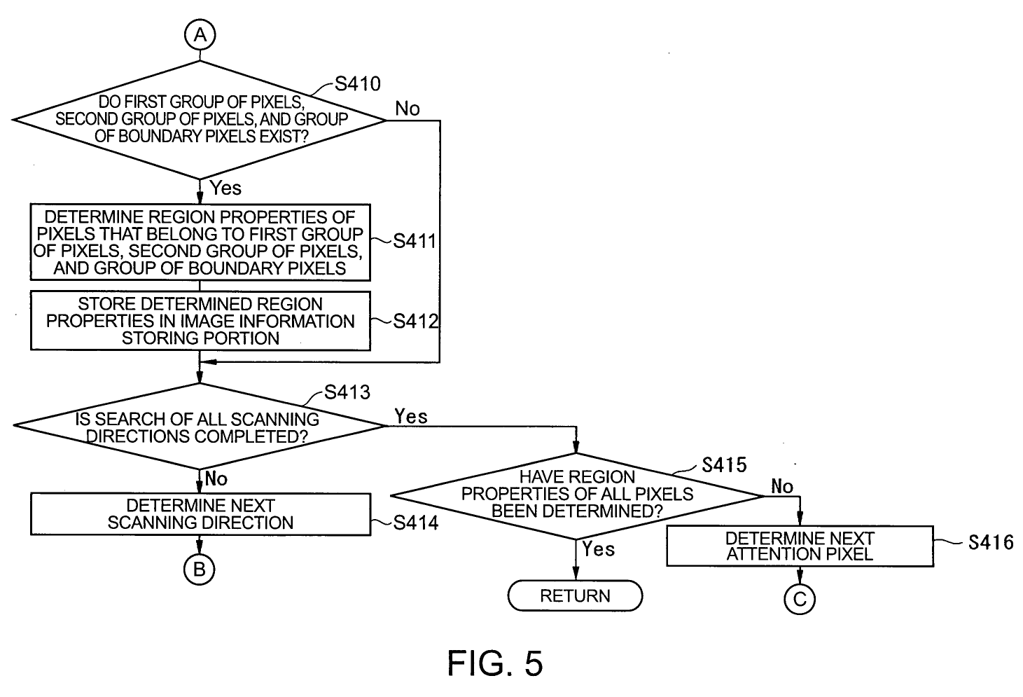

FIGS. 4 and 5 are flow charts of image change detecting processes corresponding to steps S303 and S313 of FIG. 3.

First, the initial pixel of the attention pixel p0 is determined and the attention pixel p0 is determined as a first pixel group (S401). Then, a scanning direction si in which the comparison pixels pi are sequentially searched is determined (S402).

Here, when the coordinates of the attention pixel p0 are (x0, y0), the coordinates of the comparison pixel pi are (xi, yi), and the coordinates of the scanning direction si are (sx, sy), xi=x0+i·sx, yi=y0+i·sy. Also, each of sx and sy is 1, 0, or −1, wherein i is a positive integer. For example, when the scanning direction is the direction X, (sx, sy)=(1, 0). Then, the initial pixel p1 of the comparison pixels pi is determined (S403).

Then, the group of pixels to which the comparison pixels pi belong is determined (S404). When the comparison pixels pi belong to the first group of pixels (S404: “the first group of pixels”), the comparison pixels pi are determined as the pixels that belong to the first group of pixels (S405) to thus proceed to the next step S408. When the comparison pixels pi belong to the group of boundary pixels (S404: “the group of boundary pixels”), the comparison pixels pi are determined as the pixels that belong to the group of boundary pixels (S406) to thus proceed to the next step S408. When the comparison pixels pi belong to the second group of pixels (S404: “the second group of pixels”), the comparison pixels pi are determined as the pixels that belong to the second group of pixels (S407) to thus proceed to the next step S408. When the comparison pixels pi do not belong to the above-mentioned groups of pixels (S404: “the others”), the process proceeds to the next step S410.

Then, the next new comparison pixels pi are determined (S408). That is, the pixels pi=i+1 are determined as new comparison pixels pi. Then, it is determined whether the determined comparison pixels pi exist (S409). When the comparison pixels pi exist (S409: YES), the process proceeds to step S404. When the comparison pixels pi do not exist (S409: NO), the process proceeds to step S410.

Then, it is determined whether the pixels that belong to the first group of pixels, the group of boundary pixels, or the second group of pixels exist (S410). When the pixels that belong to the first group of pixels, the group of boundary pixels, or the second group of pixels exist (S410: YES), the region properties of all of the pixels that belong to the first group of pixels, the group of boundary pixels, or the second group of pixels are determined (S411). The determined region properties are stored in the image information storing portion 211 (S412). The process proceeds to next step S413. That is, the region properties of the pixels that belong to the first group of pixels are determined as the first image object region. The region properties of the pixels that belong to the second group of pixels are determined as the second image object region. The region properties of the pixels that belong to the group of boundary pixels are determined as the boundary region between the first image object region and the second image object region. When the pixels that belong to the first group of pixels, the group of boundary pixels, or the second group of pixels do not exist (S410: NO), the process proceeds to the next step S413.

Then, it is determined whether a search in all of the scanning directions has been completed (S413). For example, when the direction X and the direction Y are the scanning directions, it is determined whether the comparison pixels pi have been searched in the two directions, that is, the direction X and the direction Y from the attention pixel p0. When a search in all of the scanning directions has not been completed (S413: NO), the next scanning direction si is determined (S414) to thus proceed to the step S403.

When the search in all of the scanning directions has been completed (S413: YES), it is determined whether the region properties of all of the pixels of the target image have been determined (S415). When the region properties of all of the pixels of the target image have not been determined (S415: NO), the next attention pixel p0 is determined (S416) to thus proceed to the step S402. When the region properties of all of the pixels of the target image have been determined (S415: YES), the processes are terminated.

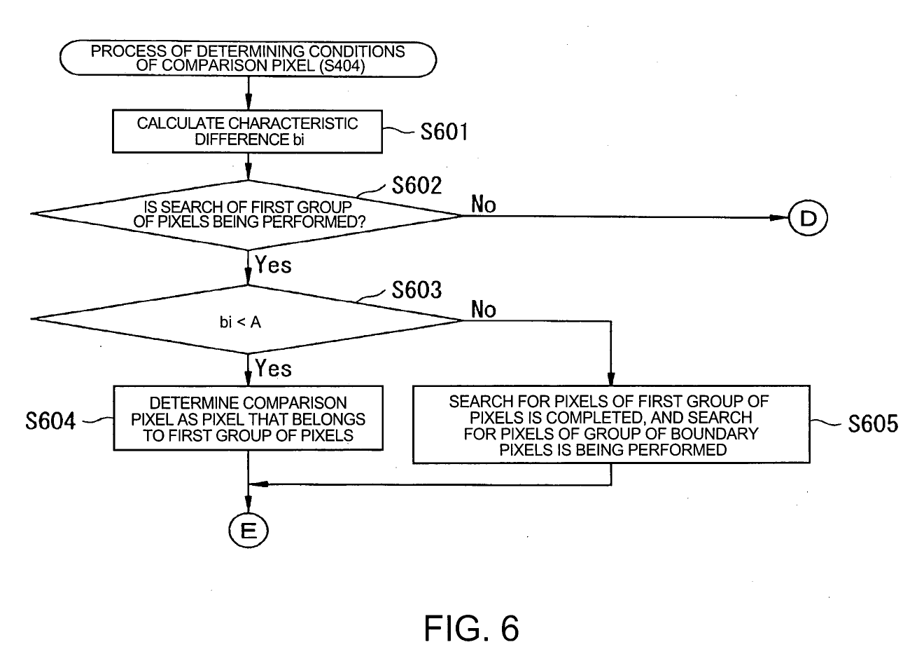

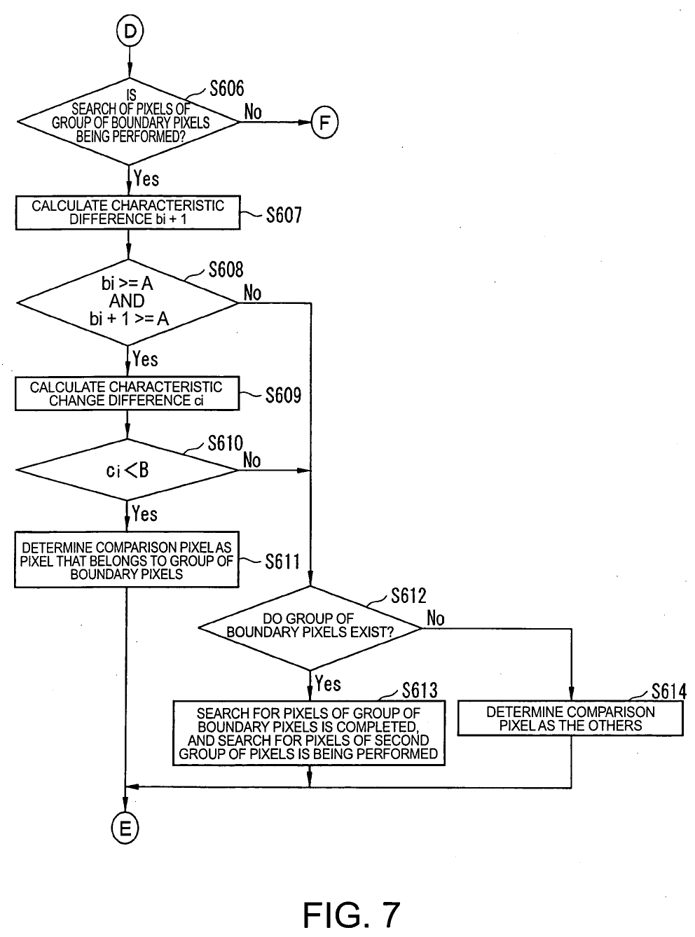

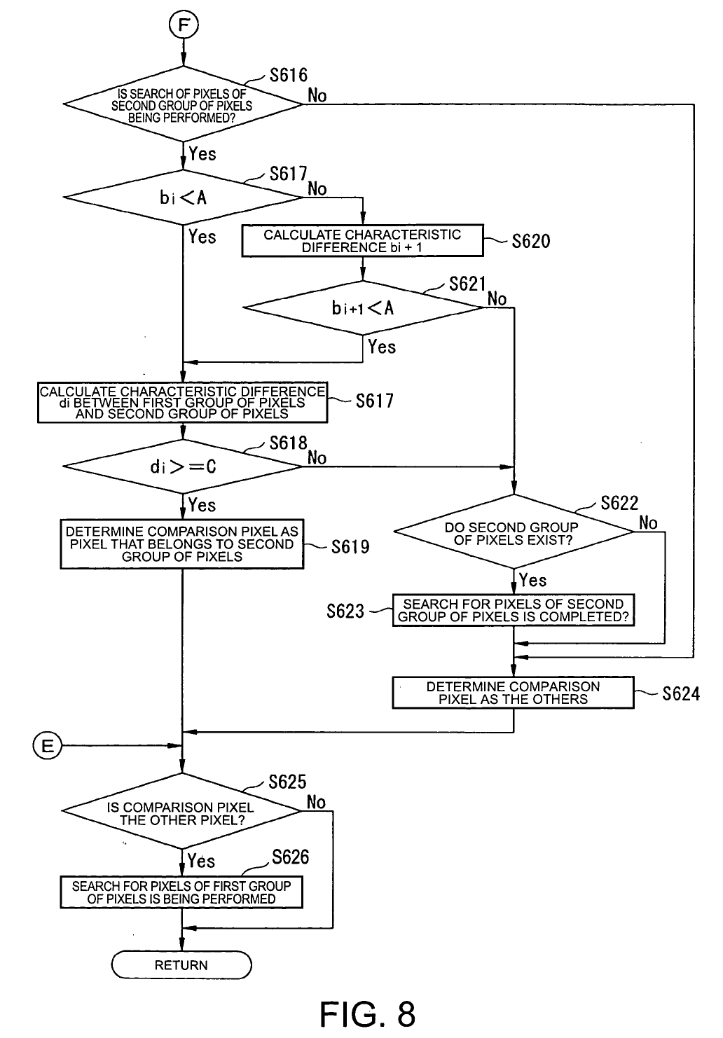

FIGS. 6 to 8 are flow charts of processes of determining the group of pixels to which the comparison pixels pi belong in the step S404 of FIG. 4 by the boundary determining conditions illustrated in FIG. 19.

First, with respect to the comparison pixels pi, the difference bi in the characteristics between adjacent pixels is calculated (S601). Then, it is determined whether the pixels that belong to the first group of pixels are searched (S602). When the pixels that belong to the first group of pixels are searched (S602: YES), it is determined whether the difference bi in the characteristics is smaller than the threshold value A (S603). When the difference bi in the characteristics is smaller than the threshold value A (S603: YES), the comparison pixels pi are determined as the pixels that belong to the first group of pixels (S604) to thus proceed to step S625. On the other hand, when the difference bi in the characteristics is equal to or larger than the threshold value A (S603: NO), it is determined that a search for the pixels that belong to the first group of pixels is completed and that a search for the pixels that belong to the group of boundary pixels is being performed (S605) to thus proceed to the step S625.

When the search for the pixels that belong to the first group of pixels is not being performed (S602: NO), it is determined whether search for the pixels that belong to the group of boundary pixels is being performed (S606). When the search for the pixels that belong to the group of boundary pixels is being performed (S606: YES), the difference bi+1 in the characteristics between adjacent pixels is calculated (S607) to thus determine whether both of the difference bi in the characteristics and the difference bi+1 in the characteristics are equal to or larger than the threshold value A (S608). When both of the difference bi in the characteristics and the difference bi+1 in the characteristics are equal to or larger than the threshold value A (S608: YES), the difference ci in the changes in the characteristics is calculated (S609) to thus determine whether the difference ci in the changes in the characteristics is smaller than the threshold value B (S610). When the difference ci in the changes is smaller than the threshold value B (S610: YES), the comparison pixels pi are determined as the pixels that belong to the group of boundary pixels (S611) to thus proceed to step S625. When both of the difference bi in the characteristics and the difference bi+1 in the characteristics are not equal to or larger than the threshold value A (S608: NO), in the case where the difference ci in the changes in the characteristics is equal to or larger than the threshold value B (S610: NO), it is determined whether the pixels that belong to the group of boundary pixels exist (S612). When the pixels that belong to the group of boundary pixels exist (S612: YES), it is determined that a search for the pixels that belong to the group of boundary pixels is completed and that a search for the pixels that belong to the second group of pixels is being performed (S613) to thus proceed to step S625. When the pixels that belong to the group of boundary pixels do not exist (S612: NO), the comparison pixels pi are determined as the other pixels (S614) to thus proceed to step S625.

When the search for the pixels that belong to the group of boundary pixels is not being performed (S606: NO), it is determined whether the search for the pixels that belong to the second group of pixels is being performed (S615). When search for the pixels that belong to the second group of pixels is being performed (S615: YES), it is determined whether the difference bi in the characteristics is smaller than the threshold value A (S616). When the difference bi in characteristics is smaller than the threshold value A (S616: YES), the difference di in characteristics between the first group of pixels and the second group of pixels is calculated (S617) to thus determine the difference di in the characteristics between the first group of pixels and the second group of pixels is equal to or larger than a threshold value C (S618). When the difference di in the characteristics between the first group of pixels and the second group of pixels is equal to or larger than the threshold value C (S618: YES), the comparison pixels pi are determined as the pixels that belong to the second group of pixels (S619) to thus proceed to step S625. When the difference di in the characteristics between the first group of pixels and the second group of pixels is smaller than the threshold value C (S618: NO), the process proceeds to the next step S622. When the difference bi in the characteristics is equal to or larger than the threshold value A (S616: NO), the difference bi+1 in the characteristics between adjacent pixels is calculated (S620) to thus determine whether the difference bi+1 in the characteristics is smaller than the threshold value A (S621). When the difference bi+1 in the characteristics is smaller than the threshold value A (S621: YES), the process proceeds to step S617. When the difference bi+1 in the characteristics is equal to or larger than the threshold value A (S621: NO), it is determined whether the pixels that belong to the second group of pixels exist (S622). When the pixels that belong to the second group of pixels exist (S622: YES), it is determined that the search for the pixels that belong to the second group of pixels is completed (S623). Then, the comparison pixels pi are determined as the other pixels (S624) to thus proceed to step S625. When the pixels that belong to the second group of pixels do not exist (S622: NO), the process proceeds to step S624. When the search for the pixels that belong to the second group of pixels is not being performed (S617: NO), the comparison pixels pi are determined as the other pixels (S624) to thus proceed to step S625.

Then, it is determined whether the comparison pixels pi are the other pixels (S625). When the comparison pixels pi are the other pixels (S625: YES), it is determined that a search for the first group of pixels is being performed (S626) to thus terminate the processes. When the comparison pixels pi are not the other pixels (S625: NO), the processes are terminated.

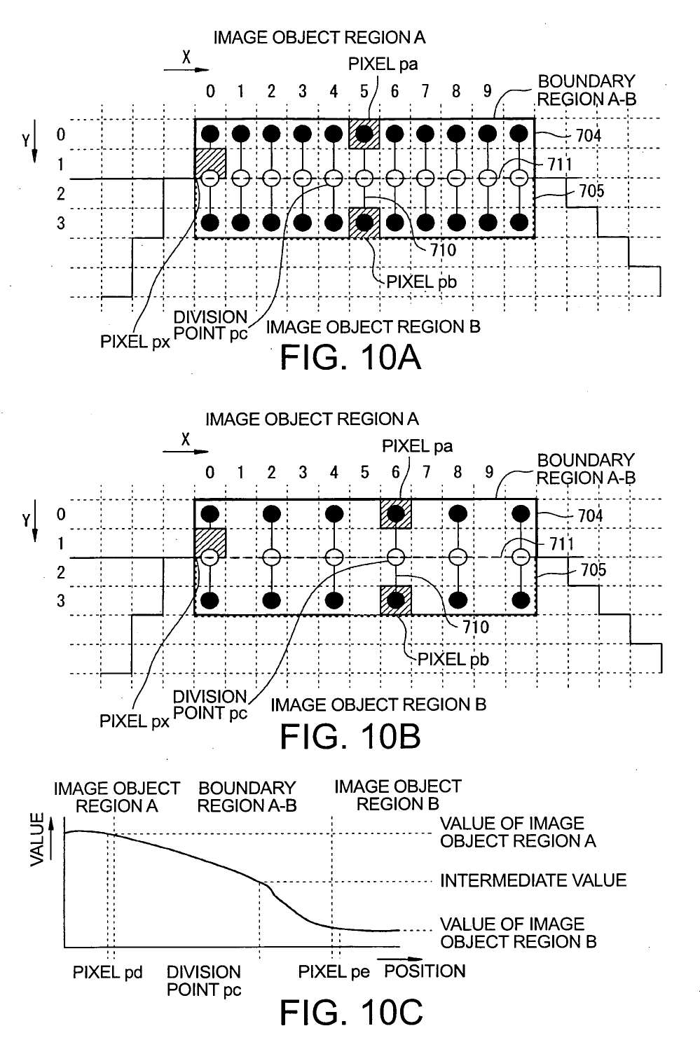

As illustrated in FIG. 9A, an example of processing a boundary region, when the boundary region exists as a region of the target image, will now be described with reference to FIG. 10. Hereinafter, a boundary region process of dividing the boundary region A-B of FIG. 9A into two divided boundary regions will now be described. FIG. 10A is a view illustrating a case in which the boundary is divided in accordance with the coordinates of the pixels that constitute the boundary region. FIG. 10B is a view illustrating an example of dividing by load reduction. FIG. 10C is a view illustrating an example of dividing the boundary region in accordance with image information on the pixels that constitute the boundary region.

As illustrated in FIG. 10A, first, of the pixels that belong to the boundary region A-B, the pixels pa that contact the image object region A are searched. Next, of the pixels that belong to the boundary region A-B, the pixels pb that exist in the direction (in FIG. 10A, in the direction Y) orthogonal to the boundary line between the near image object region A and the boundary region A-B from the pixels pa, that contact the image object region B, and that are the remotest from the pixels pa are searched. The center points of lines 710 that tie the center points of the pixels pa to the center points of the pixels pb are division points pc. Here, as illustrated in FIG. 10A, when the pixels pa are used as the pixels px that are positioned in the right and left ends of the boundary region A-B, and that contact the image object region A, the direction orthogonal to the boundary line between the image object region A and the boundary region A-B is the direction X. At this time, when the pixels pb that contact the image object region B are searched in the direction X, the pixels that contact the image object region A are searched. Therefore, search for the pixels pb that contact the image object region B is stopped.

The division points are detected with respect to all of the pixels that contact the image object region A and exist in the boundary region A-B. The line that ties all of the detected division points is a division line 711. Here, the center points of all of the pixels that contact the image object region A and that exist in the boundary region A-B and the center points of the pixels that are searched from the respective pixels, that contact the image object region B, and that exist in the boundary region A-B are marked with black circles. The division points detected by the center points are marked with white circles. The boundary region A-B is divided into two divided boundary regions 704 and 705 by the division line 711. A divided boundary region 704 that exists on the side of the image object region A based on the division line 711 is made to belong to the image object region A. A divided boundary region 705 that exists on the side of the image object region B based on the division line 711 is made to belong to the image object region B.

According to the above-mentioned example, division points are detected with respect to all of the pixels that contact the image object region A. Thus, it is possible to reduce the load of processing by detecting division points with respect to pixels separated from each other by a predetermined distance. That is, for example, as illustrated in FIG. 10A, it is possible to reduce the load of processing by detecting division points with respect to every other pixels that contact the image object region A.

According to the above-mentioned example, the center points of the lines 710 that link the respective center points of the respective pixels pa and pb that contact the image object region A and the image object region B, respectively, are the division points pc. However, the positions corresponding to the intermediate values of the pixel information items on the lines 710 may be used as the division points pc.

For example, when the pixel information is expressed by the RGB values, on the lines 710 that tie the center points of the pixels pa to the center points of the pixels pb, as illustrated in FIG. 10C, with respect to certain RGB values, the center point corresponding to the intermediate value between the value of a pixel pd of the image object region A that contacts the boundary region A-B and the value of a pixel pe of the image object region B that contacts the boundary region A-B may be used as a division point pf.

In this case, it is possible to obtain the division point pf in which main changes occur by obtaining the center point with respect to the value that most significantly changes in the image object regions among the RGB values. Also, the three potential points pf are obtained with respect to the RGB values and the position of the average of the three obtained values may be used as the final division point pf. Also, when the average is obtained, the weighted average suitable for the magnitudes of the changes of the RGB values is obtained to thus be used as the final division point pf. The method of determining the division point pf by the pixel information on the pixels is not limited to the RGB values, but can be applied to the CMYK values and the CIE L*a*b* values that are information items used as the pixel information items.

When the above-mentioned processes, as illustrated in the flow charts of FIGS. 3 to 8, are performed, the control program previously stored in the ROM 102 is executed. However, programs to perform the respective processes may be read from information recording media in which the programs are recorded and stored in the RAM 103 to thus be executed.

Here, the information recording media include all suitable recording medium including all of the information recording media that can be read by computers using any electronic, magnetic, and optical reading methods, such as semiconductor recording media including a RAM and a ROM, magnetic storage recording media including an FD and a HD, optical recording media including a CD, a CDV, an LD, and a DVD, and magnetically recording/optically reading recoding media including an MO.

Next, a second exemplary embodiment of the present invention will now be described with reference to the drawings. As in the above-mentioned exemplary embodiment, the second exemplary embodiment to be described hereinafter is an exemplary embodiment according to the present invention with only the purpose of description, but the present invention is not limited thereto. Therefore, the skilled person in the art can employ other exemplary embodiments in which other elements are substituted for each element or all elements of the second exemplary embodiment, and thus other exemplary embodiments are also included in the scope of the present invention.

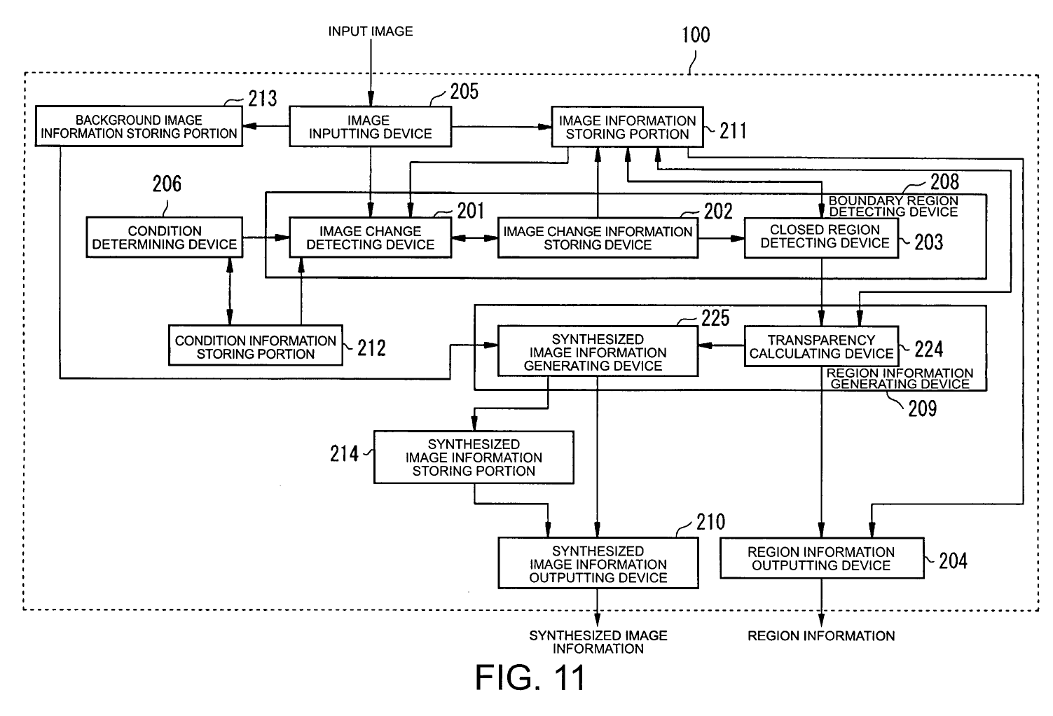

FIG. 11 is an example of a functional block schematic illustrating an image processing apparatus 100 according to the present exemplary embodiment.

The hardware structure of the image processing apparatus is the same as that of the image processing apparatus according to the foregoing exemplary embodiment.

The image processing apparatus 100 includes a boundary region detecting device 208, a region information generating device 209, a region information outputting device 204, an image inputting device 205, a condition determining device 206, and a synthesized image information outputting device 210.

The image inputting device 204 obtains image information on a target image and stores the image information in the image information storing portion 212. The image inputting device 205 generates image information required for image processing, such as dividing the target image into image regions. For example, when the input image information is in the form of the CMYK values and the image information in the form of the RGB values is required in order to divide the target image into the image regions, the image inputting device 205 generates the image information in the form of the RGB values from the image information in the form of the CMYK values and stores the generated image information in the form of the RGB values in the image information storing portion 212. Also, when a synthesized image is newly generated by attaching the selected target image object to a new background image, image information on the background image is obtained and the obtained image information is stored in the background image information storing portion 213.

The boundary region detecting device 208 detects an image object region and a boundary region in the target image. That is, in the periphery of the boundary between two adjacent image objects, a region composed of pixels that have the intermediate characteristics between the characteristics of the respective image objects is detected as the boundary region. Also, the boundary region detecting device 208 includes the image change detecting device 201, the image change information storing device 202, and the closed region detecting device 203.

The image change detecting device 201 determines the two adjacent image object regions as a first image object region and a second image object region based on the characteristics of a plurality of pixels continuously arranged in a predetermined direction from an attention pixel and the region-determining condition and detects a first group of pixels and a second group of pixels that belong to the first image object region and the second image object region, respectively, and a group of boundary pixels interposed between the first group of pixels and the second group of pixels. Here, the characteristics of the pixels are the color value, the chroma value, and the brightness value. The characteristics of the pixels are read from the image information storing portion 211. Region-determining conditions are read from the condition information storing portion 212. Also, the region properties of the pixels that belong to the respective detected groups of pixels are determined.

The image change information storing device 202 stores the region properties of the respective pixels, which are detected by the image change detecting device 201, in the image information storing portion 211 as a part of the pixel information on the pixels.

The closed region detecting device 203 reads the region properties of the respective pixels, which are stored in the image information storing portion 211, and detects continuous group of pixels that have the same region properties as closed regions.

The region information generating device 209 generates pixel information on the pixels that belong to the boundary region to generate a synthesized image obtained by synthesizing the target image object with the background image and generates region information on the target image object, which is composed of pixel information on the pixels that belong to the target image object region and the pixel information on the pixels that belong to the generated boundary region based on the changes in the characteristics from the pixels of the boundary region that contacts the target image object region to the pixels of the boundary region that contacts an adjacent image object region.

That is, when the synthesized image is created by attaching the target image object to the background image, it is possible to control the image information on the boundary region to have no sense of incongruity in the peripheral edge of the target image object region. Here, in the target image, the image object adjacent to the target image object is referred to as the adjacent image object. Also, the region composed of the pixels that have the characteristics of the target image object is referred to as the target image object region. The region composed of the pixels that have the characteristics of the adjacent image object is referred to as the adjacent image object region.

Also, the region information generating device 209 includes transparency calculating device 224 and synthesized image information generating device 225.

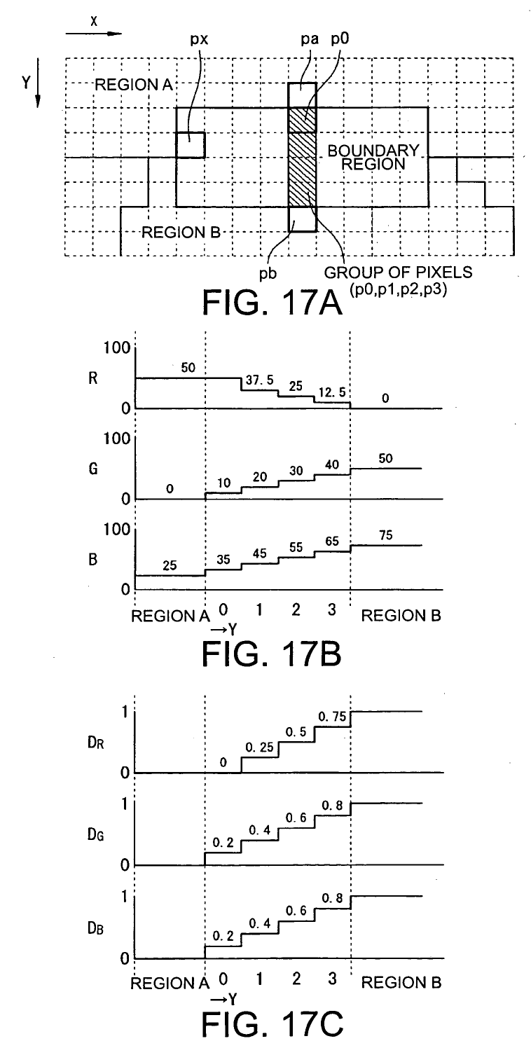

The transparency calculating device 224 explains the intermediate characteristics between the characteristics of the target image object and the characteristics of the adjacent image object numerically with respect to the pixels that belong to the boundary region and stores the numerically explained values in the image information storing portion 211 as pixel information. That is, transparencies are sequentially calculated with respect to a group of continuous pixels from the pixels of the boundary region adjacent to the target image object region to the pixels of the boundary region adjacent to the adjacent image object region in the direction orthogonal to the boundary line between the target image object region and the boundary region based on the ratio of the changes from the values of the characteristics of the pixels that belong to the target image object region to the values of the characteristics of the pixels that belong to the adjacent image object region. Here, with reference to FIG. 17, the transparencies of the pixels of the boundary region will now be described.

FIG. 17A is a schematic illustrating the order of searching pixels whose transparencies are calculated in the boundary region. FIG. 17B is a schematic illustrating the changes in the pixel information on the pixels in the boundary region. FIG. 17C is a schematic illustrating the changes in the transparencies of the pixels in the boundary region. Hereinafter, the target image object region of the target image is represented by a region A. The adjacent image object region of the target image is represented by a region B. A region interposed between the region A and the region B is represented by a boundary region.

As illustrated in FIG. 17A, among the pixels that belong to the boundary region, the pixel p0 that contacts the region A is searched. Then, the pixels pi of the boundary region, which exist in the direction (in FIG. 17A, in the direction Y) orthogonal to the boundary line between the near region A and the boundary region from the pixel p0, are searched until the pixel pi contacts the region B. That is, in FIG. 17A, the shaded group of pixels {p0, p1, p2, p3 } is searched. Then, the pixel pa of the region A, which contacts the pixel p0 in the direction opposite to the pixel p1, is searched in the direction orthogonal to the boundary line. Furthermore, the pixel pb of the region B, which is the remotest from the pixel p0 in the direction orthogonal to the boundary line and which contacts the pixel pi of the boundary region, is searched. Here, as illustrated in FIG. 17A, when the above-mentioned pixel p0 is used as the pixels px that are positioned at the right and left ends of the boundary region, the direction orthogonal to the boundary line between the near region A and the boundary region is the direction X. At this time, when the pixel pb that contacts the region B in the direction X is searched, the pixel that contacts the region A is searched. Therefore, the search for the pixel pb that contacts the region B is stopped.

FIG. 17B illustrates the changes in the RGB values of the detected group of pixels {pa, p0, p1, p2, p3, pb} in the order. Therefore, in the processes of changes from the values of the region A to the values of the region B, a ratio with which the respective pixels of the boundary region change is denoted by the transparency D. Therefore, the transparency D is represented by the following expressions, wherein, DRi, DGi, and DBi denote the transparencies of the pixel pi with respect to the RGB colors, and R(pi), G(pi), and B(pi) denote the RGB values of the pixel pi:

Dri=(R(pa)−R(pi))/(R(pa)−R(pb))

Dgi=(G(pa)−G(pi))/(G(pa)−G(pb))

Dbi=(B(pa)−B(pi))/(B(pa)−B(pb))

FIG. 17C illustrates the results of calculating the transparencies of the group of pixels {pa, p0, p1, p2, p3, pb} with respect to the RGB colors in the order.

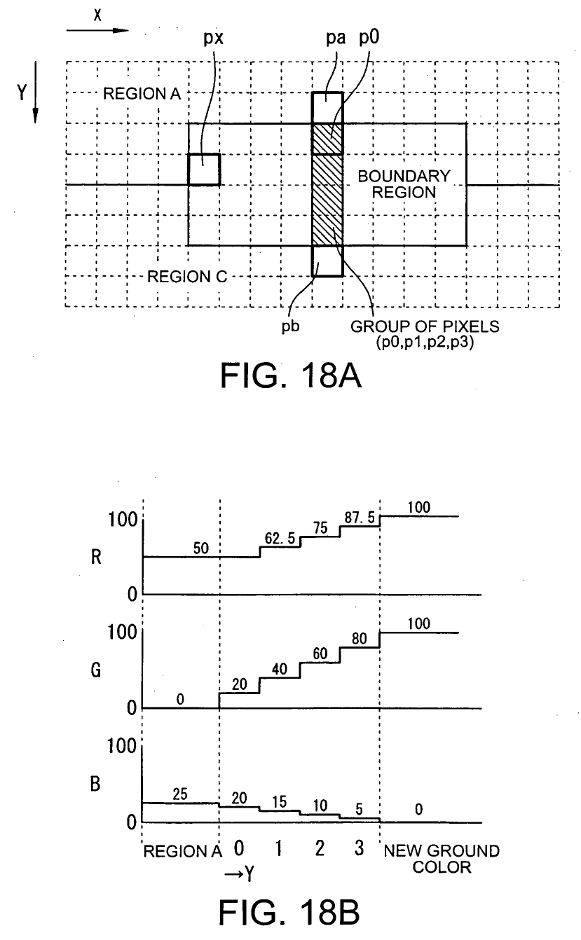

The synthesized image information generating device 225 generates a synthesized image obtained by synthesizing the target image object with the background image and stores the generated synthesized image in the synthesized image information storing portion 214. When the synthesized image is generated, with respect to the pixel information on the pixels that belong to the boundary region, based on the transparency information on the pixels, which is calculated by the transparency calculating device 224, and the pixel information on the pixels of the background image adjacent to the boundary region, which is read from the background image information storing portion 213, the pixel information on the boundary region having no sense of incongruity with the background image is newly calculated and updated. Here, with reference to FIG. 18, controlling of the pixel information on the pixels that belong to the boundary region when the target image object is synthesized with the background image will now be described.

FIG. 18A is a schematic illustrating the order of searching the pixels to control the pixel information by the background image. FIG. 18B is a view illustrating the changes in the pixel information on the pixels that belong to the boundary region by the background image. Hereinafter, when the target image object is synthesized with the background pixels, the region of the background pixels, which is adjacent to the boundary region, is referred to as a region C.

As illustrated in FIG. 18A, first, among the pixels that belong to the boundary region, the pixel p0 that contacts the region A is searched. Then, the pixels pi of the boundary region, which exist in the direction (in FIG. 18A, in the direction Y) orthogonal to the boundary line between the region A and the boundary region from the pixel p0, are searched until the pixel pi contacts the region C. That is, in FIG. 18A, the shaded group of pixels {p0, p1, p2, and p3} is searched. Then, the pixel pa of the region A, which contacts the pixel p0 in the direction opposite to the pixel p1 in the direction orthogonal to the boundary line, is searched. Furthermore, a pixel pc of the region C in the direction orthogonal to the boundary line, which is the remotest from the pixel p0 in the direction orthogonal to the boundary line and which contacts the pixel pi of the boundary region, is searched.

The RGB values are represented by the following expressions in consideration of the influences of the characteristics of the searched pixels pi and the region C, wherein, DRi, DGi, and DBi denoting the transparencies of the pixel pi with respect to the RGB colors, and R(pi), G(pi), and B(pi) denote the RGB values of the pixel pi:

R(pi)=R(pa)+(R(pc)−R(pa))×DRi

G(pi)=G(pa)+(G(pc)−G(pa))×DGi

B(pi)=B(pa)+(B(pc)−B(pa))×DBi

FIG. 18B illustrates the changes in the RGB values of the searched group of pixels {pa, p0, p1, p2, p3, pc} in the order. As illustrated in FIG. 18B, in the pixels that belong to the boundary region, it is possible to synthesize the region A with the region C with no sense of incongruity by replacing the image information on the region B of the target image that is the original image to the image information on the region C of the background image.

The synthesized image information outputting device 210 outputs the image information on the synthesized image, which is stored in the synthesized image information storing portion 214. The region information outputting device 204 adds the transparencies of the pixels of the boundary region, which are generated by the region information generating device 209, to the region information on the target image object region and the boundary region, which is detected by the boundary region detecting device 208, as transparency information and outputs the added image information as the region information on the target image object.

The condition determining device 206 reads the condition determining information used for the image change detecting device 201 detecting the region information from the condition information storing portion 212, edits the condition determining information, or adds new condition determining information. For example, it is possible to change the threshold values A, B, and C of the above-mentioned region-determining condition information, to store the changed values to the condition information storing portion 212, and to add other conditions such as the condition 4.

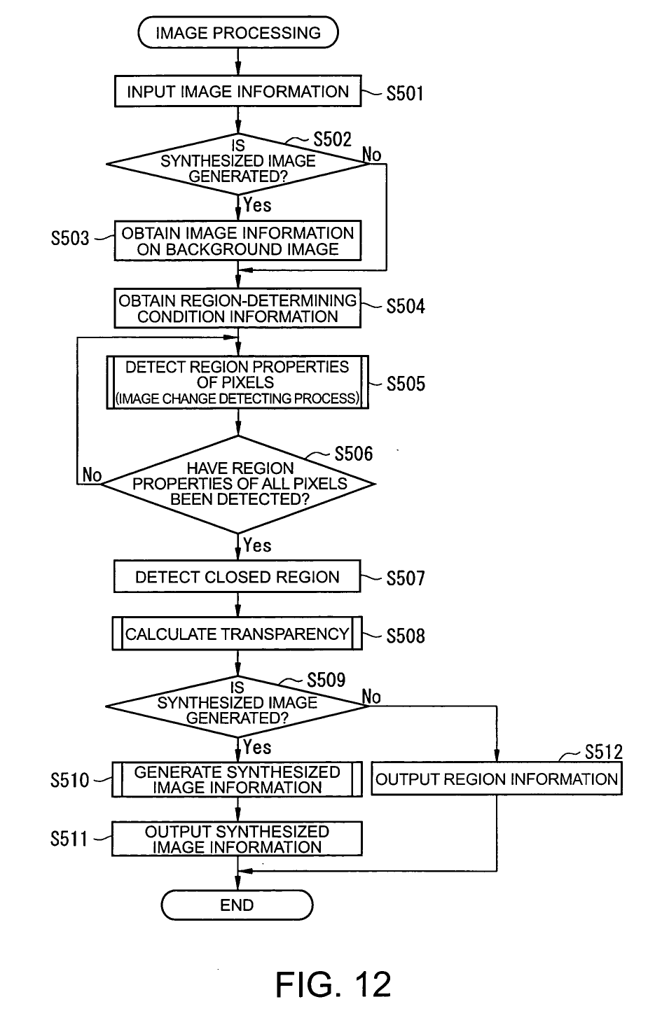

FIG. 12 is an example of a flow chart for an image process of dividing a target image into image regions composed of image object regions and boundary regions and of generating region information for a synthesized image by the control program previously stored in the ROM 102.

First, image information on the target image to be image-processed is input, and the input image information is stored in the image information storing portion 211 as pixel information each on pixel (S510). Here, it is possible to generate the pixel information required for the subsequent image process, if necessary. Next, it is determined whether a synthesized image is generated (S502). When the synthesized image is generated (S502: YES), image information on a background image is input and is stored in the background image information storing portion 213 as the pixel information on each pixel (S503). Next, region-determining condition information to divide the target image into the image object region and the boundary region is read from the condition information storing portion 212 (S504).

Next, a first group of pixels and a second group of pixels that belong to a first image object region and a second image object region, which are two adjacent image object regions, respectively, and a group of boundary pixels interposed between the first group of pixels and the second group of pixels are detected based on the characteristics of the pixels continuous in a predetermined direction from an attention pixel and the region-determining condition information read in step S504. The region properties of the pixels that belong to the respective detected groups of pixels are determined. The determined region properties of the respective pixels are stored in the image information storing portion 211 as a part of the pixel information on the pixels (S505).

Next, it is determined whether region information has been determined with respect to all of the pixels that constitute a target image (S506). When the region information has not been determined with respect to all of the pixels (S506: NO), step S503 is repeated until the region information has been determined with respect to all of the pixels. When the region information has been determined with respect to all of the pixels (S506: YES), the region properties of the pixels stored in the image information storing portion 211 are read. Continuous pixels that have the same region properties are searched. Closed regions composed of the searched pixels are detected. Region information to distinguish the image regions, which are the detected closed regions, is determined. The determined region information is stored in the image information storing portion 211 (S507).

Next, the transparencies of the pixels that belong to all of the boundary regions of the target image object are calculated. The calculated transparencies are stored in the image information storing portion 211 as one of the pixel information items (S508). Next, it is determined whether a synthesized image is generated (S509). When the synthesized image is generated (S509: YES), pixel information on the pixels that belong to all of the boundary regions of the target image object in the synthesized image is newly calculated based on image information on the background image, and the calculated pixel information is stored in the synthesized image information storing portion 214 (S510). Finally, region information on the synthesized image, which is calculated based on the image information on the background image and the transparency information, is taken out from the image information storing portion 214 and is output (S511) to thus terminate the processes. On the other hand, when the synthesized image is not generated (S509: NO), image information obtained by adding the transparency information to the pixels of the boundary region as the region information on the target image object is taken out from the image information storing portion 211 and is output (S512) to thus terminate the processes.

For example, when the target image illustrated in FIG. 23A is image-processed by the above-mentioned respective steps S505 to S507, the region properties of all of the pixels that constitute the target image are detected, and closed regions are detected by the detected region properties of the pixels. When the detected closed regions are distinguished by the region information, the target image is divided into an image object region A, an image object region B, and a boundary region A-B as illustrated in FIG. 9A. Here, as mentioned above, all of the boundary regions between the adjacent image objects in the target image are detected. However, when a synthesized image is generated, the boundary region that exists in the peripheral edge of the selected target image object may be detected. Also, when an image process is performed by the above-mentioned respective steps S508 to S510, as illustrated in FIG. 9B, the pixel information on the boundary region is updated to information with no sense of incongruity between the target image object and the background image.

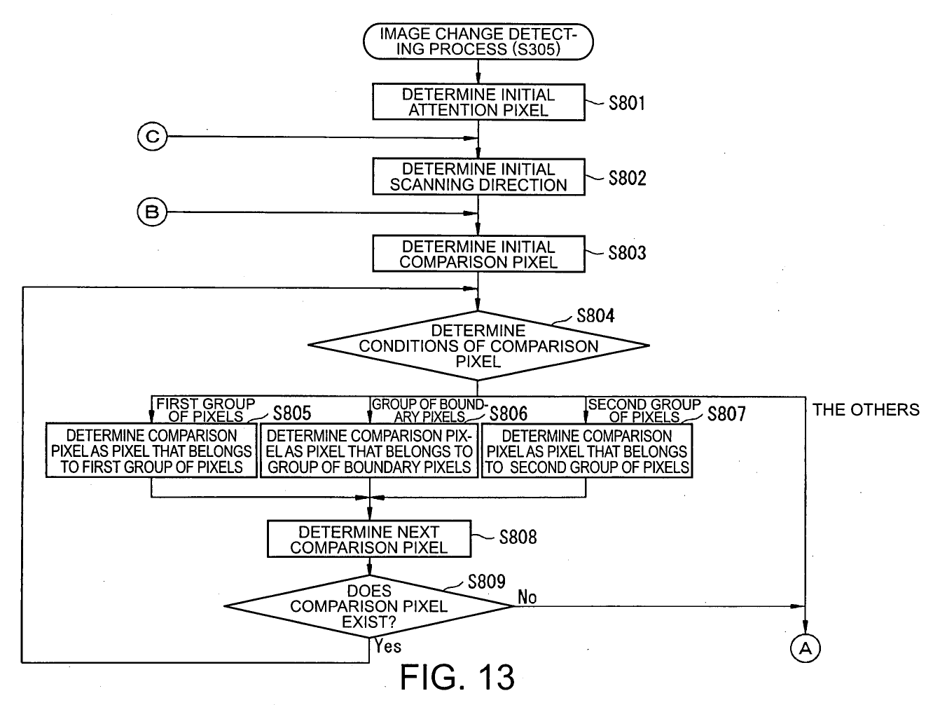

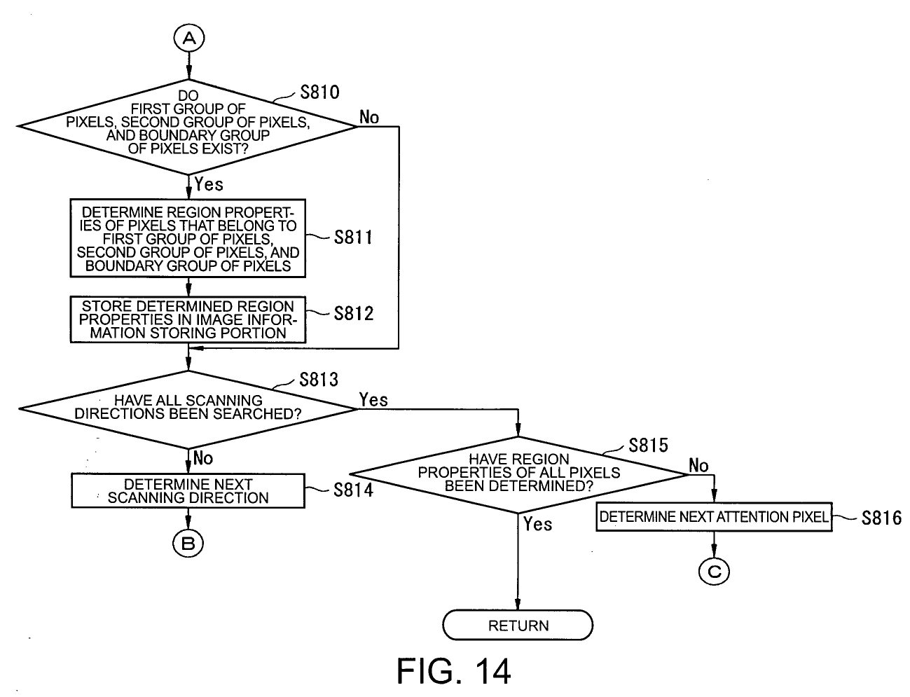

FIGS. 13 and 14 are flow charts for an image change detecting process corresponding to step S505 of FIG. 12.

First, the initial pixel of the attention pixel p0 as illustrated in FIG. 19 is determined. The attention pixel p0 is determined as a first pixel group (S801). Then, a scanning direction si in which the comparison pixels pi are sequentially searched is determined (S802). Here, when the coordinates of the attention pixel p0 are (x0, y0), the coordinates of the comparison pixel pi are (xi, yi), and the coordinates of the scanning direction si are (sx, sy), xi=x0+i×sx, yi=y0+i×sy, wherein each of sx and sy is 1, 0, or −1, and i is a positive integer. For example, when the scanning direction is the direction X, (sx, sy)=(1, 0). Then, the initial pixel p1 of the comparison pixels pi is determined (S803).

Then, according to the method illustrated in FIG. 19, the group of pixels to which the comparison pixels pi belong is determined (S804). When the comparison pixels pi belong to the first group of pixels (S804: “the first group of pixels”), the comparison pixels pi are determined as the pixels that belong to the first group of pixels (S805) to thus proceed to the next step S808. When the comparison pixels pi belong to the group of boundary pixels (S804: “the group of boundary pixels”), the comparison pixels pi are determined as the pixels that belong to the group of boundary pixels (S806) to thus proceed to the next step S808. When the comparison pixels pi belong to the second group of pixels (S804: “the second group of pixels”), the comparison pixels pi are determined as the pixels that belong to the second group of pixels (S807) to thus proceed to the next step S808. When the comparison pixels pi do not belong to the above-mentioned groups of pixels (S804: “the others”), the process proceeds to the next step S810.

Then, the next new comparison pixels pi are determined (S808). That is, i is set to be i+1 in order to determine new comparison pixels pi. Then, it is determined whether the determined comparison pixels pi exist (S809). When the comparison pixels pi exist (S809: YES), the process proceeds to step S804. When the comparison pixels pi do not exist (S809: NO), the process proceeds to step S810.

Then, it is determined whether the pixels that belong to the first group of pixels, the group of boundary pixels, or the second group of pixels exist (S810). When the pixels that belong to the first group of pixels, the group of boundary pixels, or the second group of pixels exist (S810: YES), the region properties of all of the pixels that belong to the first group of pixels, the group of boundary pixels, or the second group of pixels are determined (S811). The determined region properties are stored in the image information storing portion 211(S812). The process proceeds to the next step S813. That is, the region properties of the pixels that belong to the first group of pixels are determined as the first image object region. The region properties of the pixels that belong to the second group of pixels are determined as the second image object region. The region properties of the pixels that belong to the group of boundary pixels are determined as the boundary region between the first image object region and the second image object region. On the other hand, when the pixels that belong to the first group of pixels, the group of boundary pixels, or the second group of pixels do not exist (S810: NO), the process proceeds to the next step S813.

Then, it is determined whether search in all of the scanning directions has been completed (S813). For example, when the direction X and the direction Y are the scanning directions, it is determined whether the comparison pixels pi have been searched in the two directions, that is, in the direction X and the direction Y from the attention pixel p0. When search in all of the scanning directions has not been completed (S813: NO), the next scanning direction si is determined (S814) to thus proceed to step S803.

When the search in all of the scanning directions has been completed (S813: YES), it is determined whether the region properties of all of the pixels of the target image have been determined (S815). When the region properties of all of the pixels of the target image have not been determined (S815: NO), the next attention pixel p0 is determined (S816) to thus proceed to step S802. On the other hand, when the region properties of all of the pixels of the target image have been determined (S815: YES), the processes are terminated.

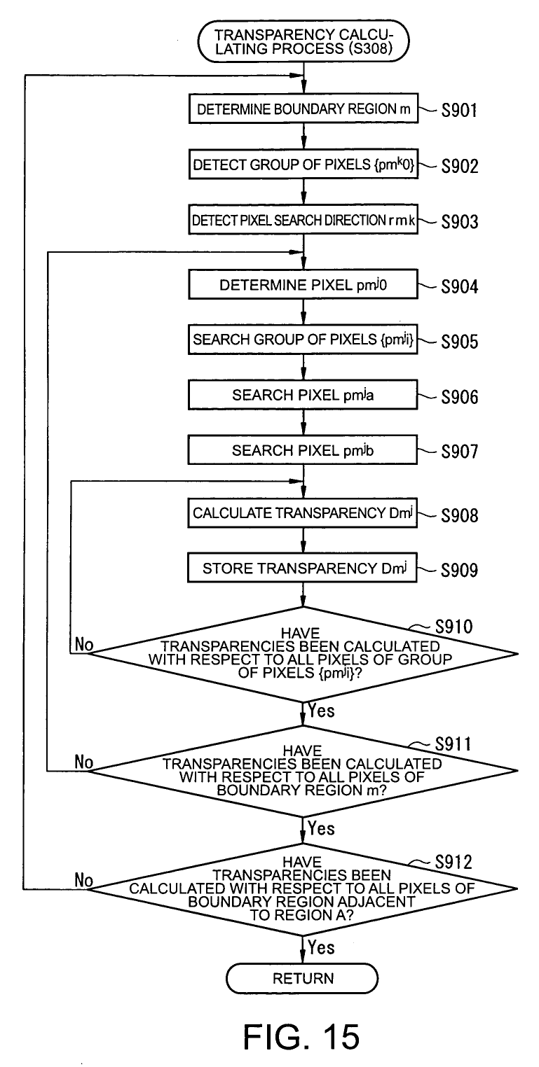

FIG. 15 is a flow chart for a transparency calculating process corresponding to step S508 of FIG. 12. Here, as illustrated in FIG. 17A, the target image object region is referred to as a region A. The adjacent image object region is referred to as a region B. A region interposed between the target image object region and the adjacent image object region is referred to as a boundary region.

First, an initial boundary region m adjacent to the region A is determined (S901). m is an identifier of the boundary region. Then, among the pixels that belong to the determined boundary region, all of the pixels adjacent to the region A are searched (S902). Here, the searched pixels are pmk0, and the group of searched pixels is {pmk0}. Also, k is an identifier of the searched pixels. Then, the direction (in the drawing, referred to as“the pixel searching direction”) orthogonal to the boundary line between the near region A and the boundary region from the pixel pmk0 is searched (S903). Here, the pixel searching direction is rmk.

Then, one pixel pmj0 out of the group of searched pixels {pmk0} is determined (S904). The determined pixel pmj0 corresponds to the pixel p0 in FIG. 17A. Then, a group of pixels {pmji} composed of all of continuous pixels pmji in the boundary region in the pixel searching direction rmj are searched (S905). In FIG. 17A, the group of pixels {pmji} corresponds to the group of pixels {p0, p1, p2, p3}. Herein, when the coordinates of the pixel pmj0 are (xmj0, ymj0), the pixels pmji are (xmji, ymji), and the pixel searching direction rmj is (rmjx, rmiy), xmji=xmj0+i×rmjx, ymji=ymj0+i×rmjy. Also, each of rmjx and rmiy is 1, 0, or −1, and i is a positive integer. For example, when the pixel searching direction is the direction X, (rmjx, rmiy)=(1, 0).

Then, the pixel pmja of the region A, which contacts the pixel pmj0 in the direction opposite to the pixel searching direction rmj, is searched (S906). Furthermore, the pixel pmjb of the region B in the pixel searching direction rj, which contacts the pixel pmji that is the remotest from the pixel pmj0, is searched (S907). At this time, as illustrated in FIG. 17A, the pixel pmj0 is used as the pixels px that are positioned in the right and left ends of the boundary region and that contact the region A, the direction orthogonal to the boundary line between the near region A and the boundary region is the direction X. At this time, when the pixel pmjb that contacts the region B in the direction X is searched, the pixel that contacts the region A is searched. Therefore, search for the pixel pmjb that contacts the region B is stopped, and the pixel pmj0 is removed from the group of pixels {pmk0}.

Then, with respect to the pixel pmji in the group of pixels {pmji}, the transparency Dmj is calculated using the following expressions (S908). The calculated transparency is stored in the image information storing portion 211 as the pixel information on the pixel pmji (S909). Here, DmjRi, DmjGi, and DmjBi denote the transparencies of the pixel pmji with respect to the respective RGB values. Also, R(pmji), G(pmji), and B(pmji) are the respective RGB values of the pixel pmji.

DmjRi=(R(pma)−R(pmji))/(R(pma)−R(pmb))

DmjGi=(G(pma)−G(pmji))/(G(pma)−G(pmb))

DmjBi=(B(pma)−B(pmji))/(B(pma)−B(pmb))

Then, steps S908 and S909 are repeated until the transparencies of all pixels of the group of pixels {pmji} are calculated (S910). That is, the transparencies of the pixel pmji with respect to all of the values of the identifier i are calculated.

Then, steps S904 to S910 are repeated until all of the transparencies of the pixels that belong to the boundary region m are calculated (S911). That is, the transparencies of the pixel pmji with respect to all of the values of the identifier j are calculated.

Finally, steps S901 to S911 are repeated until all of the transparencies of the pixels that belong to all of the boundary regions adjacent to the region A are calculated (S912), and the processes are terminated. That is, the transparencies of the pixel pmji with respect to all of the values of the identifier m are calculated.

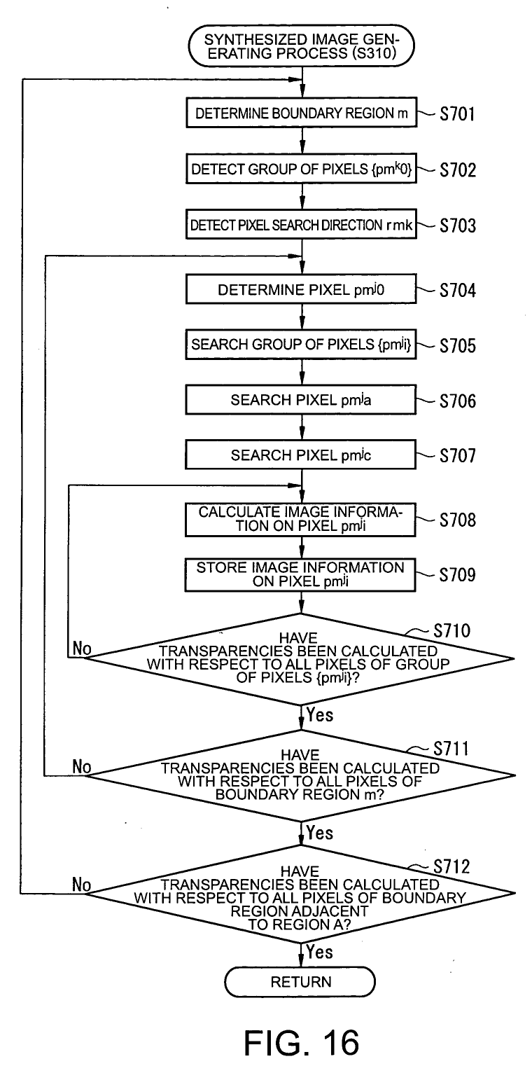

FIG. 16 is a flow chart for a synthesized image information generating process corresponding to step S510. Here, as illustrated in FIG. 1 8A, when the target image object region is referred to as a region A and the region of the background pixel adjacent to the boundary region when the target image object and the background pixel are synthesized with each other is referred to as a region C.

First, an initial boundary region m adjacent to the region A is determined (S701), wherein m is an identifier of the boundary region. Then, all of the pixels adjacent to the region A are searched from the pixels that belong to the determined boundary region (S702). Here, the searched pixel is pmk0, and the group of searched pixels is {pmk0}. Also, k is an identifier of the searched pixels. Then, the direction (in the drawing, referred to as “the pixel searching direction”) orthogonal to the boundary line between the near region A and the boundary region from the pixel pmk0 is searched (S703). Here, the pixel searching direction is rmk.

Then, one pixel pmj0 of the group of searched pixels {pmk0} is determined (S704). The determined pixel pmj0 corresponds to the pixel p0 in FIG. 18A. Then, a group of pixels {pmji} composed of all of continuous pixels pmji in the boundary region in the pixel searching direction rmj is searched (S705). In FIG. 18A, the group of pixels {pmji} corresponds to the group of pixels {p0, p1, p2, p3}. Here, when the coordinates of the pixel pmj0 are (xmj0, ymj0), the coordinates of the pixel pmji are (xmji, ymji), and the pixel searching direction rmj is (rmjx, rmiy), xmji=xmj0+i×rmjx, ymji=ymj0+i×rmjy. Also, each of rmjx and rmiy is 1, 0, or −1, and i is a positive integer. For example, when the pixel searching direction is the direction+X, (rrnjx, rmiy)=(1, 0).

Then, the pixel pmja of the region A, which contacts the pixel pmj0 in the direction opposite to the pixel searching direction rmj, is searched (S706). Furthermore, the pixel pmjc of the region C in the pixel searching direction rj, which contacts the pixel pmji that is the remotest from the pixel pmj0, is searched (S707).

Then, with respect to the pixel pmji in the group of pixels {pmji}, the respective RGB values are calculated using the following expressions in consideration of the influences of the characteristics of the region C (S708). The calculated RGB values are stored in the synthesized image information storing portion 214 as the pixel information on the pixel pmji (S709). Here, DmjRi, DmjGi, and DmjBi denote the transparencies of the pixel pmji with respect to the respective RGB values. Also, R(pmji), G(pmji), and B(pmji) are the respective RGB values of the pixel pmji.

R(pmji)=R(pma)+(R(pmc)−R(pma))×DmjRi

G(pmji)=G(pma)+(G(pmc)−G(pma))×DmjGi

B(pmji)=B(pma)+(B(pmc)−B(pma))×DmjBi

Then, steps S708 and S709 are repeated until the RGB values of all of the pixels of the group of pixels {pmji} are calculated (S710). That is, the RGB values of the pixel pmji with respect to the all of the values of an identifier i are calculated.

Then, steps S704 to S710 are repeated until all of the RGB values of the pixels that belong to the boundary region m are calculated (S711). That is, the RGB values of the pixel pmji with respect to all of the values of an identifier j are calculated.

Finally, steps S701 to S711 are repeated until all of the RGB values of the pixels that belong to all of the boundary regions adjacent to the region A are calculated (S712), and the processes are terminated. That is, the RGB values of the pixel pmji with respect to all of the values of an identifier m are calculated.

Also, according to the above-mentioned processes shown in FIG. 16, after performing the transparency calculating process of FIG. 14, pixel information on the pixels of the boundary regions for the synthesized image is calculated. However, when the synthesized image is created, the processes of steps S708 and S709 may be performed between the processes of steps S909 and S910 of FIG. 15.

In FIGS. 15 and 16, DmjRi, DmjGi, and DmjBi, which are the RGB values, as the transparency Dmj are stored in the image information storing portion 211 as the pixel information on the pixel pmji. Therefore, it is possible to reduce the amount of the pixel information on the pixel pmji by using the average of DmjRi, DmjGi, and DmjBi as the transparency Dmj. When there are no changes or small amount of changes in one or two of the RGB values between the region A and the region B, an appropriate transparency may not be obtained. In such a case, it is possible to use the transparencies of the RGB values, which change between the region A and the region B, as the transparencies of all of the RGB values. Here, when appropriate transparencies are obtained with respect to two values of the RGB values, the average of the two values may be used as the remaining one value. Furthermore, assuming that changes in the image information in the boundary regions are linear with respect to the pixel searching direction, it is possible to represent the transparency information stored in each pixel by functions and to thus store the transparency information represented by the functions.

As mentioned above, according to the present exemplary embodiment, the image processing apparatus 100 includes the boundary region detecting device 208, the region information generating device 209, the region information outputting device 204, the image inputting device 205, the condition determining device 206, and the synthesized image information outputting device 210. The boundary region detecting device 208 includes the image change detecting device 201, the image change information storing device 202, and the closed region detecting device 203. Furthermore, the region information generating device 209 includes the transparency calculating device 224 and the synthesized image information generating device 225. Therefore, even when an image object in a target image is not distinguished by clear edges and generates a boundary region of small width, it is possible to divide the boundary region into image regions and to detect the boundary region. Also, the detected boundary region may be identified as a boundary region, which is an image region different from the image object region. Therefore, it is possible to divide the target image into the image regions composed of the image object regions and the boundary regions and to detect the target image.

Furthermore, when a synthesized image is generated by synthesizing the target image object with the background image, it is possible to generate the synthesized image with no sense of incongruity around the target image object by appropriately mixing the image information on the boundary region of the divided target image object with the image information on the background image. Also, even when the synthesized image generating process is performed by another apparatus, it is possible to generate a synthesized image with no sense of incongruity around the target image object by adding the information obtained by removing the influences of the characteristics of an image object adjacent to the target image object from the image information on the boundary region of the target image object to the pixel information on the pixels of the boundary region.

What is claimed is:

1. An image processing method to detect a target image including a set of a plurality of pixels in each of a plurality of image object regions, comprising:
when one of adjacent image object regions is a first image object region and the other image object region is a second image object region, a group of boundary pixels interposed between a first group of pixels that constitute the first image object region and a second group of pixels that constitute the second image object region being detected as a boundary region between the first image object region and the second image object region based on pixel information on the pixels and predetermined region-determining conditions.

2. An image processing method to divide a target image including a set of a plurality of pixels into a plurality of image object regions, comprising:
when one of adjacent image object regions is a first image object region and the other image object region is a second image object region, a group of boundary pixels interposed between a first group of pixels that constitute the first image object region and a second group of pixels that constitute the second image object region being detected as a boundary region between the first image object region and the second image object region based on pixel information on the pixels and predetermined region-determining conditions, a division line being determined in the boundary region based on the values of the pixels that constitute the boundary region, and the boundary region being divided into a region adjacent to the first image object region and the other region adjacent to the second image object region using the division line as a boundary.

3. The image processing method according to claim 2,
pixels having intermediate values between the values of the pixels positioned along the boundary of the first image object region and the values of the pixels positioned along the boundary of the second image object region or values close to the intermediate values being selected as the division line in the boundary region so that the selected pixels are continuously arranged along the boundary.

4. An image processing method, comprising:
synthesizing an arbitrary image object region in a target image including a set of a plurality of pixels with another background image,
the arbitrary image object region being divided from another image object region adjacent to the image object through a boundary region together with the boundary region, based on pixel information on the pixels and predetermined region-determining conditions,
the image object region being synthesized with another background image together with the boundary region, and
the pixel values of a group of pixels that constitute the boundary region being controlled according to the pixel values of a group of pixels that constitute the background image.

5. The image processing method according to claim 4,
the pixel values of the group of pixels that constitute the boundary region being controlled so that the difference in the pixel values between the group of pixels that constitute the boundary region and the group of pixels that constitute the background image is gradually reduced toward the background image.

6. The image processing method according to claim 4,
transparencies of the pixel values of the group of pixels that constitute the boundary region being controlled to be gradually increased toward the background image.

7. The image processing method according to claim 1,
the predetermined region-determining conditions being the following conditions 1 to 3:
(CONDITION 1) the first group of pixels is a group of pixels in which the difference in the pixel values between adjacent pixels is smaller than a predetermined threshold value A, and which are continuously arranged in a predetermined direction from an attention pixel;
(CONDITION 2) the group of boundary pixels is a group of pixels in which the difference in the pixel values between adjacent pixels is equal to or larger than the predetermined threshold value A and the difference in the changes in the pixel values between the adjacent pixels is smaller than a predetermined threshold value B, and which are continuously arranged in the predetermined direction from the first group of pixels; and
(CONDITION 3) the second group of pixels is a group of pixels in which the difference in the pixel values between adjacent pixels is smaller than the predetermined threshold value A and the difference in the pixel values between the first group of pixels and the second group of pixels is equal to or larger than a predetermined threshold value C, and which are continuously arranged in the predetermined direction from the group of boundary pixels.

8. An image processing apparatus to detect a target image including a set of a plurality of pixels in each of a plurality of image object regions, the image processing apparatus, comprising:
a boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region, based on pixel information on the pixels and predetermined region-determining conditions.

9. An image processing apparatus to detect a target image including a set of a plurality of pixels in each of a plurality of image object regions and to divide the image object regions to thus synthesize the divided image object regions with other background images, the image processing apparatus, comprising:
a boundary region detecting device to detect, when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions; and
a region information generating device to divide any one of the first image object region and the second image object region together with the boundary region to thus synthesize the divided image object region and boundary region with the background image and to control the pixel values of the group of pixels that constitute the boundary region according to the pixel values of the group of pixels that constitute the background image.

10. An image processing program, comprising:
a program to detect a target image including a set of a plurality of pixels in each of a plurality of image object regions,
and to detect a boundary region when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions.

11. An image processing program, comprising:
a program to detect a target image including a set of a plurality of pixels in each of a plurality of image object regions and to divide the image object regions to thus synthesize the divided image object regions with other background images;
to detect a boundary region when one of adjacent image object regions is a first image object region and the other image object region is a second image object region, a group of boundary pixels interposed between a first group of pixels that constitute the first image object region and a second group of pixels that constitute the second image object region as a boundary region between the first image object region and the second image object region based on pixel information on the pixels and predetermined region-determining conditions; and
to generate a region information to divide any one of the first image object region and the second image object region from another adjacent image object region together with the boundary region to thus synthesize the divided image object region and boundary region with the background image and to control the pixel values of the group of pixels that constitute the boundary region according to the pixel values of the group of pixels that constitute the background image.

12. An image processing apparatus, for dividing a target image including a plurality of pixels into a plurality of image object regions based on pixel information on the pixels, comprising:
when one of adjacent image object regions is a first image object region and the other image object region is a second image object region, in a group of pixels continuously arranged in a predetermined direction and existing on the boundary between the first image object region and the second image object region and in the vicinity of the boundary, the group of pixels composed of the pixels having intermediate characteristics between the characteristics of the first image object region and the characteristics of the second object region being detected as a boundary region between the first image object region and the second image object region based on predetermined region-determining conditions.

13. The image processing apparatus according to claim 12, further comprising:
an image change detecting device to detect the pixels that belong to a first group of pixels including the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and for identifying them by region attributes;
an image change information storing device to store the region attributes of the pixels detected by the image change detecting device in a predetermined storage unit as the pixel information on the pixels;
a closed region detecting device to detect a group of pixels composed of continuous pixels having the same region attributes as a closed region based on the region attributes of the pixels stored by the image change information storing device; and
a region information outputting device to output region information to identify the boundary region or the image object region to which the closed region detected by the closed region detecting device belongs.

14. The image processing apparatus according to claim 13, the predetermined region-determining conditions being the following conditions:
(CONDITION 1) the first group of pixels is a group of pixels in which the difference in the pixel values between adjacent pixels is smaller than a predetermined threshold value A, and which is continuously arranged in a predetermined direction from an attention pixel;
(CONDITION 2) the group of boundary pixels is a group of pixels in which the difference in the pixel values between adjacent pixels is equal to or larger than the predetermined threshold value A and the difference in the changes in the pixel values between the adjacent pixels is smaller than a predetermined threshold value B, and which are continuously arranged in the predetermined direction from the first group of pixels; and
(CONDITION 3) the second group of pixels is a group of pixels in which the difference in the pixel values between adjacent pixels is smaller than the predetermined threshold value A and the difference in the pixel values between the first group of pixels and the second group of pixels is equal to or larger than a predetermined threshold value C, and which are continuously arranged in the predetermined direction from the group of boundary pixels.

15. The image processing apparatus according to claim 13,
the predetermined directions being at least two different directions among the directions of the lines that link the center of an attention pixel to the centers of the pixels that contact the attention pixel.

16. The image processing apparatus according to claim 12, further comprising:
a boundary region processing device to divide the boundary region between the detected first image object region and second image object region into two divided boundary regions based on predetermined boundary region dividing conditions and to determine to which region each of the divided boundary regions belongs between the first image object region and the second object region.

17. The image processing apparatus according to claim 12, further comprising:
an image inputting device to input image information on the target image, to generate the pixel information on the pixels that constitute the target image, which is required to divide the target image into the image regions, and to store the pixel information in a predetermined storage unit.

18. The image processing apparatus according to claim 12, further comprising:
a condition determining device to determine the predetermined region-determining conditions and to store the predetermined region-determining conditions in a predetermined storage unit.

19. An image processing method, comprising:
dividing a target image including a plurality of pixels into a plurality of image regions based on pixel information on the pixels,
when one of adjacent image object regions is a first image object region and the other image object region is a second image object region, in a group of pixels continuously arranged in a predetermined direction and existing on the boundary between the first image object region and the second image object region and in the vicinity of the boundary, the group of pixels composed of the pixels having intermediate characteristics between the characteristics of the first image object region and the characteristics of the second object region being detected as a boundary region between the first image object region and the second image object region based on predetermined region-determining conditions.

20. The image processing method according to claim 19, further comprising:
(a) detecting an image change by detecting the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and of identifying them by region properties;
(b) storing an image change information by storing the region properties of the pixels detected by the image change detecting in a predetermined storage unit as the pixel information on the pixels;
(c) detecting a closed region by detecting a group of pixels composed of continuous pixels having the same region properties as a closed region based on the region properties of the pixels stored in the image change information storing; and
(d) outputting a region information by outputting region information to identify the boundary region or the image object region to which the closed region detected in the closed region detecting belongs.

21. The image processing method according to claim 20, further comprising:
between the closed region detecting (c) and the region information outputting (d), (e) processing a boundary region by dividing the boundary region between the first image object region and the second object region, which is detected in the image change detecting, into two divided boundary regions based on predetermined boundary region dividing conditions and of determining to which region each of the divided boundary regions belongs between the first image object region and the second object region.

22. An image processing program, comprising:
a program that divides a target image including a plurality of images into a plurality of image regions based on pixel information on the pixels and that is executable by a computer,
when one of adjacent image object regions is a first image object region and the other image object region is a second image object region, in a group of pixels continuously arranged in a predetermined direction and existing on the boundary between the first image object region and the second image object region and in the vicinity of the boundary, the group of pixels composed of the pixels having intermediate characteristics between the characteristics of the first image object region and the characteristics of the second object region being detected as a boundary region between the first image object region and the second image object region, based on predetermined region-determining conditions.

23. The image processing program according to claim 22, the program, further comprising:
(a) detecting an image change by detecting the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and of identifying them by region properties;
(b) storing an image change information by storing the region properties of the pixels detected in the image change detecting in a predetermined storage unit as the pixel information on the pixels;
(c) detecting a closed region by detecting a group of pixels composed of continuous pixels having the same region properties as a closed region based on the region properties of the pixels stored in the image change information storing;
(d) outputting a region information by outputting region information to identify the boundary region or the image object region to which the closed region detected in the closed region detecting belongs; and
(e) processing a boundary region by dividing the boundary region between the first image object region and the second object region, which is detected in the image change detecting, into two divided boundary regions based on predetermined boundary region dividing conditions and of determining to which region each of the divided boundary regions belongs between the first image object region and the second object region.

24. An image processing apparatus to divide the image information of a target image including a plurality of pixels into a plurality of image object regions based on pixel information on the pixels, comprising:
when an arbitrary image object region of the target image is used as a target image object region and the image object region in the target image, which is adjacent to the target image object region, is used as an adjacent image object region, in a group of pixels existing on the boundary between the target image object region and the adjacent image object region and in the vicinity of the boundary, the pixel information on the pixels that belong to a region corresponding to the group of pixels is generated based on the changes in the characteristics of the pixels in the predetermined directions in the group of pixels composed of the pixels having intermediate characteristics between the characteristics of the target image object region and the characteristics of the adjacent image object region.

25. The image processing apparatus according to claim 24, further comprising:
a boundary region detecting device to detect, as a boundary region, the group of pixels composed of the pixels having the intermediate characteristics between the characteristics of the target image object region and the characteristics of the adjacent image object region in the group of pixels continuously arranged in a predetermined direction and existing in the vicinity of the boundary between the target image object region and the adjacent image object region, based on predetermined region-determining conditions; and
a region information generating device to generate the pixel information on the pixels that belong to the boundary region, based on the changes in the characteristics of the pixels from the pixels that contact the target image object region to the pixels that contact the adjacent image object region out of the pixels that belong to the boundary region.

26. The image processing apparatus according to claim 25,
the region information generating device including a transparency calculating device to calculate the transparencies of all of the pixels from the pixels in the boundary region adjacent to the target image object region to the pixels in the boundary region adjacent to the adjacent image object region in the pixels continuously arranged in a direction orthogonal to the boundary line between the target image object region and the boundary region, based on the ratio of the changes in the characteristics of the pixels from the pixels that contact the target image object region to the pixels that contact the adjacent image object region.

27. The image processing apparatus according to claim 26, the region information generating device including synthesized an image information generating device to update the pixel information on the pixels that belong to the boundary region to information suitable for the background image to generate the pixel information on a synthesized image, based on the image information on the background image adjacent to the boundary region and the transparencies calculated by the transparency calculating device, in the synthesized image obtained by synthesizing the group of pixels of the target image object region and the boundary region with the background image.

28. The image processing apparatus according to claim 26, further comprising:
a region information outputting device to add the transparencies calculated by the transparency calculating device to the region information on the image object region and the pixel information on the pixels that belong to the boundary region as transparency information, and to output the added information as region information on the image object region.

29. The image processing apparatus according to claim 27, further comprising:
a synthesized image information outputting device to output pixel information on the synthesized image generated by the synthesized image information generating device.

30. The image processing apparatus according to claim 25, the boundary region detecting device including: an image change detecting device to detect the pixels that belong to a first group of pixels composed of the pixels having the characteristics of the first image object region, a second group of pixels composed of the pixels having the characteristics of the second image object region, or a group of boundary pixels interposed between the first group of pixels and the second group of pixels, based on the characteristics of a plurality of pixels continuously arranged in a predetermined direction from an attention pixel, which is an arbitrary pixel of the target image, and the predetermined region-determining conditions, and to identify them by region properties;
an image change information storing device to store the region properties of the pixels detected by the image change detecting device in a predetermined storage unit as the pixel information on the pixels; and
a closed region detecting device to detect a group of pixels composed of continuous pixels having the same region properties as a closed region based on the region properties of the pixels stored by the image change information storing device.

31. The image processing apparatus according to claim 25, further comprising:
a condition determining device to determine the predetermined region-determining conditions and to store the determined region-determining conditions in a predetermined storage unit.

32. The image processing apparatus according to claim 24, further comprising:
an image inputting device to input the image information on the target image or the image information on the background image, generating the image information on the target image in a form of an internal process, and storing the generated image information in a predetermined storage unit.

33. An image processing method, comprising:
dividing the image information of a target image including a plurality of pixels into a plurality of image object regions based on pixel information on the pixels,
when an arbitrary image object region of the target image is used as a target image object region and the image object region in the target image, which is adjacent to the target image object region, is used as an adjacent image object region, in a group of pixels existing on the boundary between the target image object region and the adjacent image object region and in the vicinity of the boundary, the pixel information on the pixels that belong to a region corresponding to the group of pixels being generated based on the changes in the characteristics of the pixels in the predetermined directions in the group of pixels composed of the pixels having intermediate characteristics between the characteristics of the target image object region and the characteristics of the adjacent image object region.

34. The image processing method according to claim 33, further comprising:
(a) detecting a boundary region by detecting the group of pixels composed of the pixels having the intermediate characteristics between the characteristics of the target image object region and the characteristics of the adjacent object region as a boundary region, based on predetermined region-determining conditions, in the group of pixels continuously arranged in a predetermined direction around the boundary between the target image object region and the adjacent image object region; and
(b) generating a region information by generating the pixel information on the pixels that belong to the boundary region, based on the changes in the characteristics of the pixels from the pixels that contact the target image object region to the pixels that contact the adjacent image object region out of the pixels that belong to the boundary region.

35. The image processing method according to claim 34,
the region information generating step (b) including calculating a transparency by calculating the transparencies of all of the pixels from the pixels of the boundary region adjacent to the target image object region to the pixels of the boundary region adjacent to the adjacent image object region in the pixels continuously arranged in a direction orthogonal to the boundary line between the target image object region and the boundary region, based on the ratio of the changes in the characteristics from the pixels that contact the target image object region to the pixels that contact the adjacent image object region.

36. The image processing method according to claim 35,
the region information generating (b) including generating an image information by updating the pixel information on the pixels that belong to the boundary region to information suitable for the background image and of generating the pixel information on a synthesized image, based on the image information on the background image adjacent to the boundary region and the transparencies calculated in the transparency calculating, in the synthesized image obtained by synthesizing the group of pixels of the target image object region and the boundary region with the background image.

37. The image processing method according to claim 35, further comprising:
outputting a region information by adding the transparencies calculated in the transparency calculating to the region information on the image object region and the pixel information on the pixels that belong to the boundary region as transparency information and of outputting the added information as region information on the image object region.

38. The image processing method according to claim 36, further comprising:
outputting a synthesized image information by outputting image information on the synthesized image generated in the synthesized image information generating.

39. An image processing program, comprising:
a program that divides the image information of a target image including a plurality of pixels into a plurality of image object regions based on pixel information on the pixels and that is executable by a computer,
when an arbitrary image object region of the target image is used as a target image object region and the image object region of the target image, which is adjacent to the target image object region, is used as an adjacent image object region, in a group of pixels existing on the boundary between the target image object region and the adjacent image object region and in the vicinity of the boundary, the pixel information on the pixels that belong to a region corresponding to the group of pixels being generated based on the changes in the characteristics of the pixels in predetermined directions in the group of pixels composed of the pixels having intermediate characteristics between the characteristics of the target image object region and the characteristics of the adjacent image object region.

40. The image processing program according to claim 39, the program further comprising:
(a) detecting a boundary region by detecting the group of pixels composed of the pixels having the intermediate characteristics between the characteristics of the target image object region and the characteristics of the adjacent object region as a boundary region, based on predetermined region-determining conditions, in the group of pixels continuously arranged in a predetermined direction around the boundary between the target image object region and the adjacent image object region; and
(b) generating a region information by generating the pixel information on the pixels that belong to the boundary region, based on the changes in the characteristics of the pixels from the pixels that contact the target image object region to the pixels that contact the adjacent image object region out of the pixels that belong to the boundary region.

41. The image processing program according to claim 40,
the region information generating (b) including calculating a transparency by calculating the transparencies of all of the pixels from the pixels of the boundary region adjacent to the target image object region to the pixels of the boundary region adjacent to the adjacent image object region in the pixels continuously arranged in a direction orthogonal to the boundary line between the target image object region and the boundary region, based on the ratio of the changes in the characteristics of the pixels from the pixels that contact the target image object region to the pixels that contact the adjacent image object region.

42. The image processing program according to claim 41,
the region information generating (b) including generating an image information by updating the pixel information on the pixels that belong to the boundary region to information suitable for the background image and of generating the pixel information on a synthesized image, based on the image information on the background image adjacent to the boundary region and the transparencies calculated in the transparency calculating device, in the synthesized image obtained by synthesizing the group of pixels of the target image object region and the boundary region with the background image.

43. The image processing program according to claim 41, further comprising:
outputting a region information by adding the transparencies calculated in the transparency calculating to the region information on the image object region and the pixel information on the pixels that belong to the boundary region as transparency information and of outputting the added information as region information on the image object region.

44. The image processing program according to claim 42, further comprising:
outputting a synthesized image information by outputting image information on the synthesized image generated in the synthesized image information generating.
